(19) United States
(12) Patent Application Publication
(10) Pub. No.: US 2003/0110190 A1
(43) Pub. Date: Jun. 12, 2003

(54) Method and system for file space management

(75) Inventors: Kyosuke Achiwa, Tokyo (JP); Kazuhiko Mogi, Tokyo (JP); Manabu Kitamura, Tokyo (JP); Katsunori Nakamura, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/013,966

(22) Filed: Dec. 10, 2001

(51) Int. Cl. G06F 12/00

(52) U.S. Cl. 707/203

(57) ABSTRACT

A data storage management method and apparatus provide for moving of one or more files from a first storage system (e.g., a storage client site) to a second storage system (e.g., a storage server site). A file is copied to the second storage system and is deleted from the first storage system, thus recovering storage space in the first storage system. A logical reference is provided in the first storage system so as to allow access requests to be made to the file from the first storage system, even though it has been deleted. The logical reference also allows for the file to be reproduced in the first storage system at an appropriate time.

### CROSS-REFERENCES TO RELATED APPLICATIONS

Not Applicable

### BACKGROUND OF THE INVENTION

The present invention relates to data storage systems and in particular to distributed data storage systems.

The computer is ubiquitous in business and in private use. Its daily use produces a flood of information streaming through the thousands of private and public access communication networks which connect together most computers. This volume of information eventually rests in various data storage facilities ranging from floppy disks to terabyte storage systems.

In any given business operation, much of the information accumulated is pertinent to that business and so it must be retained. However, not all of the data is required all of the time. Typically, only a small percentage of the total accumulated information is needed at a given time. One technique for dealing with massive volumes of data is to provide large file server systems which provide high capacity storage capability. This brute force approach incurs the expense of acquiring and maintaining the storage facilities.

Another technique is to archive or otherwise relocate less active data away from the main storage system. This allows for the provisioning of a high performance data storage system, but absent the high capacity requirement since less active data is stored onsite.

### SUMMARY OF THE INVENTION

In accordance with various aspects of the present invention, a data storage management method and apparatus include moving of one or more files from a first storage system (e.g., a storage client site) to a second storage system (e.g., a storage server site). A file is copied to the second storage system and is deleted from the first storage system, thus recovering storage space in the first storage system by moving the file in this manner. A logical reference is provided in the first storage system so as to allow access requests to be made to the file from the first storage system, even though it has been deleted. The logical reference also allows for the file to be moved back to the first storage system at an appropriate time.

In an aspect of the invention, additional storage systems can be provided wherein files are moved among the storage systems.

In another aspect of the invention, a storage service provider includes a storage management system operating in accordance with the foregoing, thus providing offsite storage for its clients. Clients are charged according to the storage utilization incurred.

### BRIEF DESCRIPTION OF THE DRAWINGS

FIG. 1 is a high level schematic system diagram of an illustrative embodiment of one aspect of the present invention;

FIGS. 2A-2C illustrate a file structure and associated processing pertinent to an embodiment of the aspect of the present invention shown in FIG. 1;

FIG. 3 is a flow chart showing the procedure of read/write processing in an operational situation in accordance with an embodiment of the present invention;

FIG. 4 is a flow chart showing the procedure of read/write processing in another operational situation in accordance with an embodiment of the present invention;

FIG. 5 shows the invention as used in a storage service provider operation;

FIG. 6 is a high level schematic system diagram of an illustrative embodiment of another aspect of the present invention;

FIG. 7 illustrates the file system manipulations according to the illustrative embodiment of FIG. 6;

FIGS. 8 and 9 show the processing pertinent to an embodiment of the aspect of the invention shown in FIG. 6;

FIG. 10 is a high level schematic system diagram of an illustrative embodiment of yet another aspect of the present invention;

FIG. 11 shows the file system manipulations according to the illustrative embodiment shown in FIG. 10;

FIG. 12 shows the processing pertinent to an embodiment of the aspect of the invention shown in FIG. 10;

FIGS. 13A and 13B illustrate an embodiment of still yet another aspect of the present invention;

FIG. 14 shows the processing pertinent to an embodiment of the aspect of the invention shown in FIGS. 13A and 13B;

FIG. 15 is a high level schematic system diagram of an illustrative embodiment of still another aspect of the present invention;

FIG. 16 shows the file system manipulations according to an embodiment of the aspect of the invention of FIG. 15; and

FIGS. 17A-17C illustrate the processing in accordance with an embodiment of the aspect of the invention shown in FIG. 15.

### DESCRIPTION OF THE SPECIFIC EMBODIMENTS

Embodiments of the present invention will now be described in detail with reference to the drawings.

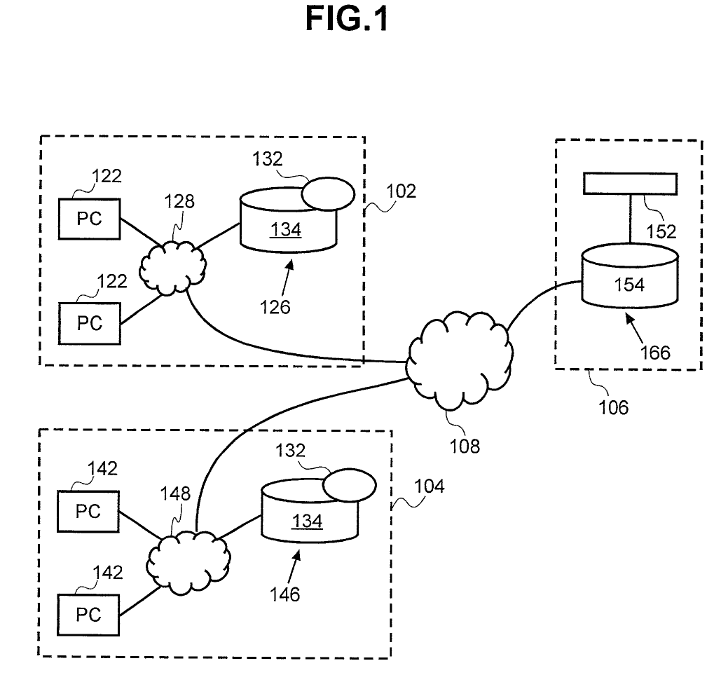

FIG. 1 shows a high level diagram of an illustrative embodiment in accordance with a first aspect of the present invention. A typical business environment 102 (“office A”) uses a plurality of computer systems 122 of varying sorts, including but not limited to desktop models which have their own primary storage devices, workstations which rely on remote storage devices as their source of primary storage, laptops, and so on, which collectively are herein referred to as PCs. The operating environment contemplated by the present invention is one in which the PCs frequently or at least occasionally need to access some sort of remote storage. The PCs are connected to an internally provided data communication network 128, e.g., a local area network (LAN). This connection can be provided by any of a number of known techniques, including wired technologies such as ethernet connections and wireless technologies such as infra-red links and radio wave links (e.g., IEEE 802.11 DSSS, Bluetooth).

A storage device 126 operable in accordance with this first aspect of the present invention is provided. In an illustrative embodiment, the storage device is a network-attached storage (NAS) device, but can be any appropriate storage device. The NAS device serves as a locally accessed remote storage system for the PCs in the business environment 102. The NAS device comprises a controller portion 132 operatively coupled to a data storage portion 134. The controller portion comprises known computer processing technology, typically a computer with appropriate software to provide the necessary operational capabilities to operate as a data server. In addition, programming code is provided to operate the storage device in accordance with the present invention.

The physical composition of the data storage portion 134 can be any of known conventional mass storage data systems. For example, the data storage portion may be any of the known RAID (redundant array of independent disks) class storage devices. The particular storage system type is not pertinent to the practice of the present invention, as should be clear to those of ordinary skill in the relevant arts. The operational aspects of the controller portion 132 will be described in detail below.

The operating environment contemplated by the various aspects of the present invention includes one or more additional business environments, e.g. business environment 104 (“office B”). The additional business environment also comprises plural PCs 142, each having some need to access a remote storage device. A data communication network 148 connects the PCs to a storage device 146 (e.g., a NAS device) which serves as a locally accessed remote storage device for the business environment 104. According to an embodiment of the present invention, the storage device is a NAS device which includes a controller portion 132 operatively coupled to a data storage portion 134. The computer processing technology used in the controller portion of the storage device 146 in the second business environment 104 can be different from that used in the controller portion of the storage device 126 in the first business environment 102. For example, CPUs (central processing units) from different manufacturers might be used. In one case, a general CPU might be used to implement the controller portion. In another case, the controller portion may be implemented using a customized microcontroller-based architecture. Similarly, the physical composition of the data storage portion of the storage device 146 in the second business environment can be different from that of the data storage portion of the storage device 126 employed in the first business environment 102.

Typical business environments include financial institutions, engineering firms, academic centers, medical facilities, manufacturing plants, and the like. These operations typically handle large amounts of data, including data of a nature which are accessed infrequently. The present invention is suited for all such environments, but of course is not limited to a “business,” being suited also for all computing environments in general and in general for any computing environment which can benefit from having off-site storage.

Continuing with FIG. 1, each of the business environments 102, 104 has access to a data communication network 108 that is external to their operation, e.g. a wide-area network (WAN). This might be a T1 connection, or a higher capacity connection, for example. The specific details of such data connections are conventional and known. The communication network provides access, among other things, to a remote server site 106.

In the illustrated embodiment of this first aspect of the invention, a NAS device 166 is provided at the remote server site 106 and accessible over the communication network 108. The NAS device 166 comprises a controller portion 152 operatively coupled to a data storage portion 154. The controller portion as discussed above in connection with NAS devices 126, 146 may comprise any conventional computer processing system. Similarly, the data storage portion of the NAS device 166 may comprise any conventional appropriate data storage system. The operational aspects of the controller portion 152 will be discussed below.

To distinguish among the NAS devices 126, 146, and 166, the following naming convention will be adopted. The NAS devices 126 and 146, located in their respective business environments 102, 104 will be referred to as “upper NASs,” or variations thereof. The NAS device 166 will be referred to as the “lower NAS.”

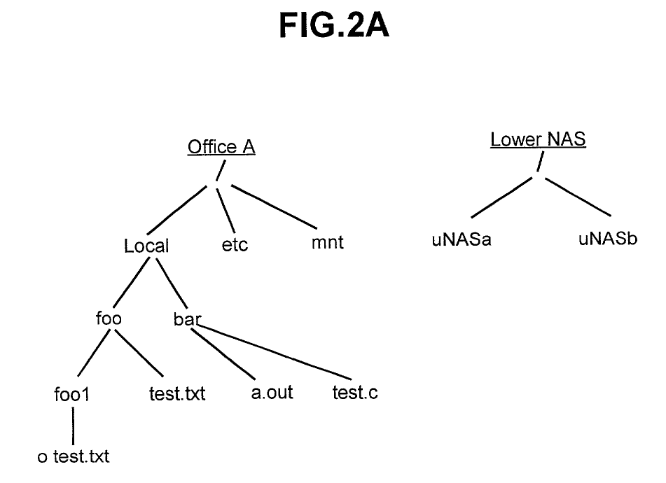

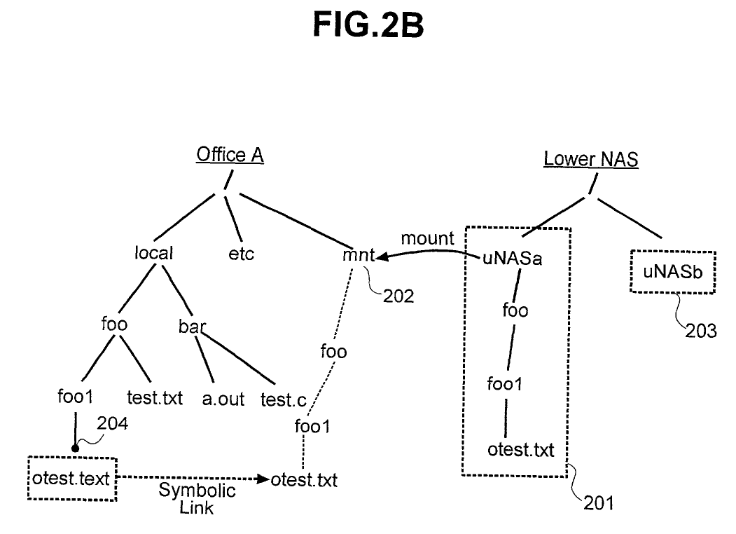

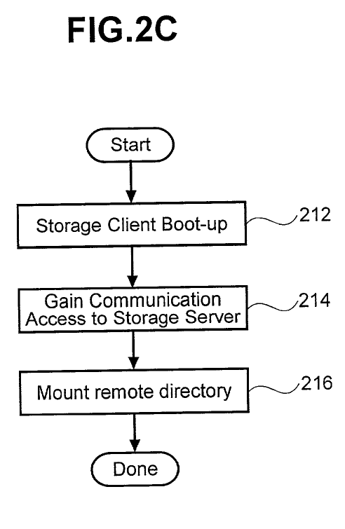

Refer now to FIGS. 2A and 2B for a discussion of the data organization of the upper and lowers NASs 126, 146, 166 according to the illustrative embodiment. The operating system (OS) is a UNIX-based OS. Many variations of UNIX exist. The disclosed illustrative embodiment employs an implementation of UNIX known as BSD, formerly known as Berkeley UNIX. Data files stored by the upper and lower NAS's are arranged in a hierarchical directory structure characteristic of UNIX-type file systems. The features of the file system used in this embodiment of the invention are known to anyone having familiarity with BSD and with UNIX in general. Moreover, the ideas presented herein can be adapted by persons of ordinary skill in the relevant arts to work with the file systems of other OS's to provide the disclosed aspects of the invention. Though other file systems may be lacking in the features of the BSD file system, it is noted that equivalent functionality can nevertheless be provided without undue experimentation. Note that the discussion which follows uses the terms directory and sub-directory interchangeably. It is conventionally accepted to refer to a directory other than ‘root’ as either a “directory” or a “sub-directory”, as all directories in a UNIX-type file system (other than ‘root’) are also sub-directories.

FIG. 2A shows a snapshot of the file system in the NAS device 126 of “office A” 102. As is typical of a BSD file system (and in general, UNIX OS's), the topmost directory is identified by the forward slash character ‘/’. This is commonly referred to as the root directory. Below the root directory are typical system subdirectories, including for example such directories as ‘etc’, ‘mnt’, and ‘dev’. Also shown is a user-created directory called ‘local’. By convention, and for the purpose of explaining the various aspects of the invention, all user files produced by users in “office A” will be located somewhere underneath the ‘/local’ directory. In the example shown, the directory ‘/local’ has two subdirectories called ‘foo’ and ‘bar’. The figure shows that directory ‘foo’ contains yet another subdirectory called ‘foo1’ and a data file called ‘test.txt’. The subdirectory ‘foo1’ contains a data file ‘otest.txt’. Traversing back to the directory called ‘bar’, there are two files contained in that directory, ‘a.out’ and ‘test.c’. Though it is not shown in the figure, it is understood that “office B” 104 has a similar file system, though the directory structure of the user-created directories in “office B” of course is likely to be quite different from that of “office A”.

FIG. 2A also shows the file system of the lower NAS 166. That file system contains the root directory. Below it are the standard system subdirectories, e.g., ‘etc’, ‘dev’, ‘mnt’, and user-created subdirectories in accordance with an illustrated embodiment of the invention, namely ‘/uNASa’ and ‘/uNASb’. The naming convention of these user-created subdirectories, of course, is not pertinent to the practice of the invention. It is clearly understood, of course, that the ‘/uNASa’ and ‘/uNASb’ can be located anywhere in the file system of the lower NAS. The directory ‘/uNASa’ is associated with “office A” 102, while the directory ‘/uNASb’ is associated with “office B” 104. More particularly, the directory ‘/uNASa’ is intended to contain portions of the user-created directories in the NAS device 126. Likewise, the directory ‘/uNASb’ is intended to contain portions of the user-created directories in the NAS device 146. How this comes about will become clear in the following discussions.

Referring now to FIG. 2B, the interrelationship between the two file systems, that of “office A” 102 and of the lower NAS 166, will be described. The BSD operating system provides a system utility for linking together file systems from two OS's. The operation is referred to as “mounting” one file system onto another file system. The solid arrow in the figure illustrates the process. A system administration process running on the OS in “office A” 102 issues a “mount” command to the lower NAS 166 at the remote server site 106. The system administration process will typically be an automated procedure. However, a human operator can manually perform “mount” and “unmount” operations; for example, during unscheduled events.

The solid arrow shown in FIG. 2B shows logically what occurs in response to the particular “mount” operation. A directory tree 201 in the file system of the lower NAS 166 (e.g., directory ‘/uNASa’ and its subdirectories) is mounted to a mount point 202 (‘/mnt’) in the file system of “office A” 102. The result is that the subdirectories in ‘/uNASa’, which physically reside on the file system of the lower NAS, are now accessible by the file system of “office A” via the ‘/mnt’ directory as if they resided on the file system of “office A”. This is shown in the figure by the dashed lines stemming from the mount point 202, illustrating that the mounted directory tree 201 appears to reside in the file system of “office A”.

Another system feature of the BSD file system that is pertinent to the present invention is the symbolic link. A user command (typically provided via a ‘shell’ interface) provides the user with the ability to create a symbolic link to a file. This feature is also provided as a library utility for software developers.

FIG. 2B shows an example of a symbolic link. At a first location 204 in the file system of “office A” 102 there appears to be a file having the pathname ‘/local/foo/foo1/otest.txt’. However, this “file” is actually a symbolic link to the physical file located in ‘/mnt/foo/foo1/otest.txt’. The symbolic link ‘/local/foo/foo1/otest.txt’ consumes no disk space for storing data, requiring only an entry in the directory data structure for the directory ‘/local/foo/foo1’. The symbolic link feature is illustrated in the figure by a dashed arrow.

The configuration shown in FIG. 2B further illustrates another feature of the BSD OS that is pertinent to the present invention. It is that symbolic links can be made to a mounted file system. Here, it can be seen that the symbolic link ‘/local/foo/foo1/otest.txt’, is linked to the file ‘otest.txt’ which physically resides in the lower NAS 166 of the remote site 106.

Referring back to FIG. 1, it can be seen that “office B” 104 can also access the remote server site 166. Like “office A” 102, “office B” can mount a directory tree from the file system of the lower NAS 166. In particular, a directory tree 203 is provided in the lower NAS for “office B”. All communications between the two office sites (“office A” and “office B”) and the lower NAS occur over the communication network 108. The variety of communication protocols that can be used between the sites are very well known and conventional.

FIG. 2C is a high level flow diagram illustrating the startup processing of a storage client in accordance with the illustrated embodiment. For the purpose of the discussion which follows, the foregoing mentioned working environments such as “office A” 102 and “office B” 104 will be generally referred to as a storage client site, the client side, and by other similar terms. The remote server site 106 described above will be referred generally by a variety of phrases such as a storage server site, data storage provider, storage service provider (SSP), the remote, and other similar terms.

Referring then to FIGS. 1 and 2C, the storage client site 102 at system boot-up (step 212) will first establish communication to a storage server site 106, step 214. The specifics of this action depend on the particular communication architecture being used. For example, this step may be as simple as dialing up the storage server site over a high speed modem. In a more sophisticated environment, the storage client site may have a high speed data line (e.g., T3 line) to the storage server site. These architectures are common, conventional, and well known.

Next, in step 216, the storage client site 102 gains access to at least a portion of the file system of storage server site 106. This may involve some sort of login sequence to establish that the storage client site has the proper authorization. In the context of the present invention, the result of this step is that the storage client site can read and write files to that part of the storage server site file system for which access has been gained. Moreover, as will be discussed below, a logical reference can be made to those files in the storage server site from the file system of the storage client site.

In terms of the illustrated embodiment, step 216 amounts to performing a mount operation of some portion of the file system of the storage server site 106; e.g., FIG. 2B shows that directory tree 201 is mounted by the storage client site 102. The storage client site will require knowledge about which part of the storage server file system to access and mount. In BSD, this is a pathname in the server's file system. This information can be predetermined by previous arrangement between the storage client site and the storage server site. However, for security reasons, the server can send the information to the client each time the client is rebooted. This might involve a series of communication exchanges between the client and the server. The identity of the storage client site would be required by the storage server site to validate the accessing client and so that access to the proper part of the storage server's file system can be provided. The server would then transmit the pathname to be mounted by the client.

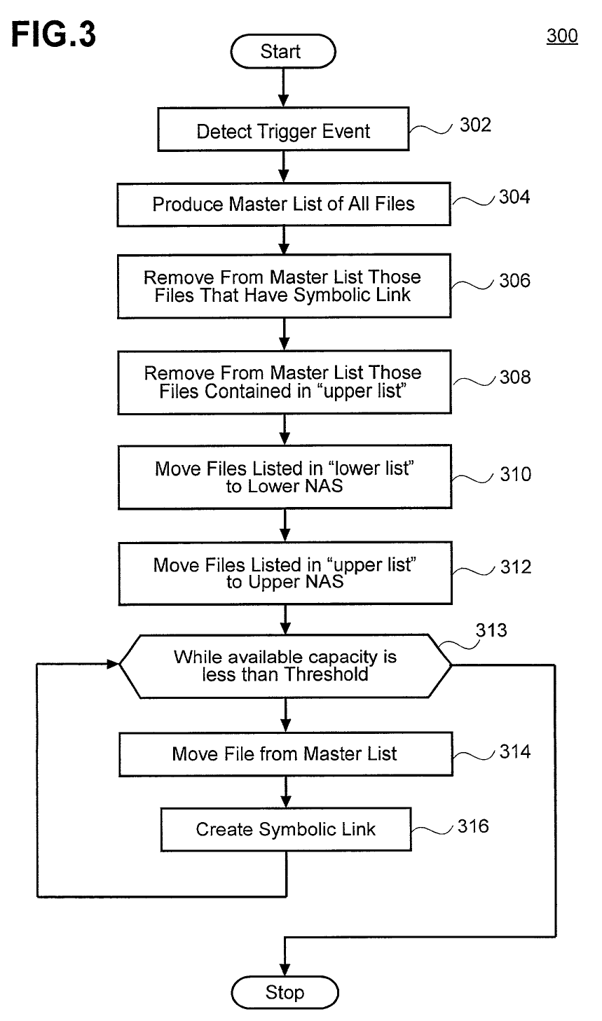

Processing in accordance with this first aspect of the present invention generally involves moving files from the storage client site to the storage server site. Referring then to FIGS. 1 and 3, a flowchart 300 illustrates data storage management processing in a storage client site 102, 104 in accordance with an illustrative embodiment of this aspect of the invention. Appropriate computer programs are provided in the controller portion 132 of the storage device 126 of each storage client site to perform data storage management in accordance with this aspect of the invention. In addition, certain modifications to the OS may be required depending on the particular implementation strategy used in a given environment. Collectively, these programs and OS modifications are referred to as the hierarchical manager (HM) which comprise the controller portion of the storage device. Factors not pertinent to the present invention will determine the specific implementation details and solutions of the hierarchical manager; e.g. size of the office operation, performance criteria, and so on. Moreover, though UNIX-based systems have features which readily lend themselves to implementations according to the invention, it is understood that other OS's can be adapted in accordance with the invention to provide the described features of the invention.

Processing of the hierarchical manager begins with the detection of a triggering event at the storage client site, step 302. The triggering event can be a scheduled event where the storage management process is performed periodically. The triggering event can be initiated by a system level process on a demand basis. For example, a system administrator may initiate the process manually. The triggering event might even be initiated by non-system administration user (though typically not the case).

A detection of a near disk full condition could be the triggering event. Thus, for example, if say 95% of the total capacity of the disk has been allocated for file storage (or conversely, that only 5% available storage capacity remains), such a condition might warrant triggering the processing to manage the storage on the disk. This condition can be detected, for example, by a “cron” process that runs periodically to check the available disk space.

In response to the triggering event, a master list of the files (candidate files) that should be “moved” to the storage server site 106 in accordance with the present invention is produced. In the illustrated embodiment of the invention, the master list is created by producing a first list which lists (i.e., names) all of the files in the local file system of the storage client site, step 304. Those files in the first list that are in fact symbolic links are removed from the first list, step 306; there is no need to process those files that are symbolic links, since such files consume no storage space in the local file system. Also, as will become apparent, some of the files that are symbolic links are files which will have previously been moved to the storage server site.

Continuing, files that are also listed in an “upper list” are removed (filtered, or otherwise excluded) from the first list, step 308. This “upper list” names those files in the storage client site which a priori have been deemed should not be moved to the storage server site 106. Upon filtering the first list with the “upper list”, a second list (i.e., the master list) results which contains only those files that should be moved to the storage server site. The “upper list” can be modified at any time, including deletions, and so the foregoing filtering step should be performed each time when the triggering event is detected.

In the context of the present invention, the notion of “moving” a file from the storage client site to the storage server site is characterized by the following properties. First, the contents of the “moved” file are duplicated in the physical storage of the storage server site, thus preserving the contents of the “moved” file offsite relative to the storage client site. A mechanism is required to retain information about the original location of the file in the storage client site. Such a mechanism is provided by creating subdirectories in the storage server site which ensures that the filename of the “moved” file is placed in the storage server site file system in a location corresponding to the location of the filename as it existed in the storage client site file system. Second, the physical storage occupied by the local copy of the file in the storage client site is made available for subsequent allocation by the file system.

Typically, this is achieved by deleting the file from the file system, thus increasing the available storage capacity of the physical storage space at the storage client site. Third, a logical reference to the “moved” file is created in the storage client site. The logical reference is a referencing mechanism which allows users at the storage client site to refer to the file via the local file system as if the file had not been deleted.

In accordance with the illustrated embodiment of this first aspect of the present invention, the foregoing described action of moving a file from the storage client site to the storage server site can be provided by the file system of the BSD OS. In the environment of the BSD OS, a file to be moved is first copied to the storage server site. This is readily accomplished by invoking the appropriate system utilities to effect a copy operation of the file from the storage client site to produce a duplicated file on the storage server site. Next, the local copy of the file in the storage client site is deleted. Then, a symbolic link is created in place of the deleted file to the file at the storage server site. Referring to FIG. 2B for a moment, the file /local/foo/foo1/otest.txt has been copied over to the storage server site (i.e. “local NAS”) from the storage client site (i.e., “office A”). A symbolic link having the same file name has been created in place of the old file name, as shown by the dashed box. Thus to a user in the storage client site, it would appear that the file ‘otest.txt’ still exists on the local file system. This aspect of moving a file from a storage client site to the storage server site according to the invention can be provided in other OS's which do not support the file mounting and symbolic link features of the BSD OS, but which provide similar functionality.

Continuing with FIG. 3, files listed in a “lower list” are moved to the storage server site 106, step 310. The “lower list” specifies those files which have been deemed (e.g. by the system administrator and/or users) should always be stored at the storage server site. This is ensured by performing this step each time the trigger event is detected. Thus, if a file in the list has not already been moved to the storage server site, it will be moved accordingly. As with the “upper list”, the “lower list” can be modified and so its contents can change. Also, as will be explained below, a file in the “lower list” will be moved from the storage server site to the storage client site if it is accessed. Consequently, this list should be processed on each occurrence of the triggering event.

BSD OS provides a last-access time parameter, ‘atime’, associated with each file. When a file is accessed, the OS updates its associated atime parameter to the current time to reflect that it was just accessed. Thus, when the file is moved to the storage server site, the atime parameter of the duplicated file on the storage server site will be updated. However, it is desirable to retain the atime value of the file prior to being moved to the storage server site. Similarly, when a duplicated file is copied back to the storage client site, the atime value of the reproduced file at the storage client site should be set to the atime value of the duplicated file. Consequently, the atime parameter of the duplicated file is modified so that its value is the atime value of the file prior to it being moved to the storage server site.

Next, files in the “upper list” are moved from the storage server site to the storage client site, step 312. This action guarantees that those files listed in the “upper list” are in fact physically located at the storage client site.

In the context of the present invention, the notion of “moving” a file from the storage server site 106 to the storage client site involves creating a copy of the file in the physical storage of the local file system of the storage client site. In terms of the BSD OS, this means copying the file from the storage server site to the storage client site thus re-creating (reproducing) the file at the storage client site along with updating the atime parameter as described above. The file at the storage server site is deleted. The symbolic link is then deleted and replaced with a reference to the file in the local file system.

After the files listed in the “lower list” and the “upper list” have been moved accordingly, the files in the master list are moved one at a time from the storage client site to the storage server site 106. This is repeated for each file until the available disk capacity increases above a predetermined threshold, say 20%. Thus, files in the master list are moved until the available disk capacity exceeds 20% (for example), step 313. The least recently accessed files are moved first (step 314), since they represent the least active files. In terms of the BSD OS embodiment of the invention, this can achieved by sorting the files in the master list based on atime. This parameter represents the time that the file was last accessed, either for reading or writing. For each file that is moved to the storage server site, a symbolic link is created in the storage client site, as discussed above, step 316.

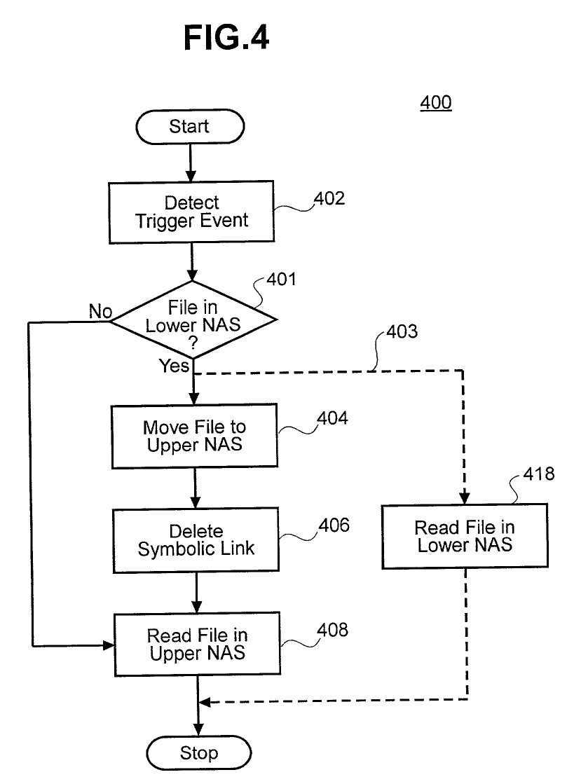

Referring to FIGS. 1 and 4, another aspect of the hierarchical manager is shown. As in the processing shown in FIG. 3, a triggering event is detected, step 402. Here the triggering event is a user-initiated or an application-initiated file access, such as a read or a write operation. In the BSD OS, appropriate software trapping mechanisms can be provided to detect a file access. It should be appreciated by those ordinary skill in the relevant arts that “trapping” a file I/O request can be readily accomplished with appropriate modifications to the OS. Specifically, it is necessary to trap the ‘creat’ and ‘open’ system calls by modifying either the syscallo function, or both the creato and openo system library functions.

A decision point, step 401, ascertains whether the accessed file is at the storage server site 106 (lower NAS in FIG. 1). If the file is not located at the storage server site, then the file is simply accessed from the local file system of the storage client site 102, step 408.

If the file is located at the storage server site, then the file is moved back to the storage client site. This involves creating a copy of the file in the local storage system of the storage client site, step 404. The action includes deleting the copy of the file in the storage server site. The symbolic link in the client is deleted and replaced with a reference to the local file, step 406. The file is then accessed to service the user-initiated or application-initiated file access, step 408.

FIG. 4 shows alternative processing for the case where the file is located in the storage server site 106. As can be seen, the contents of the file can simply be accessed from the storage server site, step 418. There is no copying of the file back to the storage client site. This approach may be appropriate in certain situations. For example, when the available capacity of the client site (e.g., upper NAS) is so low that moving files back from the server site (e.g., lower NAS) would quickly fill the client site file system, then the move operation should not be performed, and step 418 should be performed instead

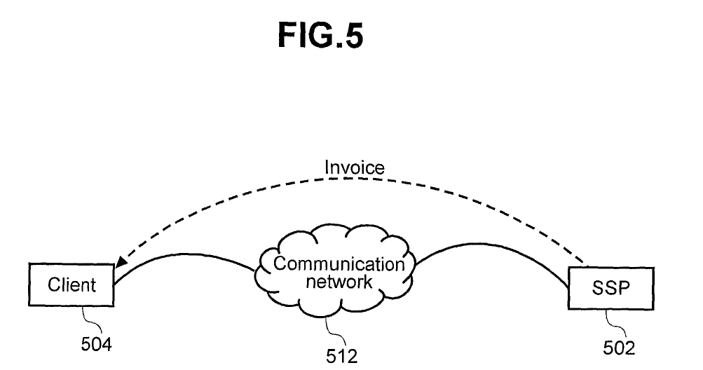

FIG. 5 shows in another embodiment of this first aspect of the present invention, the disclosed data storage method as used in a storage service provider (SSP) environment. An arrangement is made between a client 504 who has high capacity storage needs and an SSP 502. The SSP provides access of a directory tree from its file system to the client. Appropriate software is provided to the client to provide the client with the functions of the hierarchical manager. The client mounts the directory tree in the SSP's file system associated with the client. Then as the client site creates and deletes files, references files, and so on, the hierarchical manager moves files back and forth in accordance with the invention as described above.

In the meanwhile, the SSP monitors the physical storage usage of the client. The SSP requests payment (e.g., in the form of a monthly fee) from the client of an amount according to the physical storage consumed by the client. Under this arrangement, the client pays only for the physical storage space it uses. In one variation of an SSP embodiment of the invention, for example, a monthly charge for physical storage service can be produced. The charge could be based on an average of the amount of physical storage space consumed by the client during a billing period. In another variation of an SSP embodiment, the billing method could be based on a maximum use of physical storage during a period of time, say a one month period. For example, suppose the consumption pattern is the following: day(storage consumed)—1st(10 GB), 2nd(123 GB), 3rd(8 GB) . . . 10th(12 GB) . . . 29th(8 GB), and 30th(9 GB). Here the client consumed the most storage on day 2 for 123 GB. Thus in accordance with the maximum-use billing method, the client would be billed based on 123GB for the billing period. As shown in FIG. 5, an invoice can be sent via conventional postal delivery methods, or electronically (e.g., by email) over a suitable communication network 512.

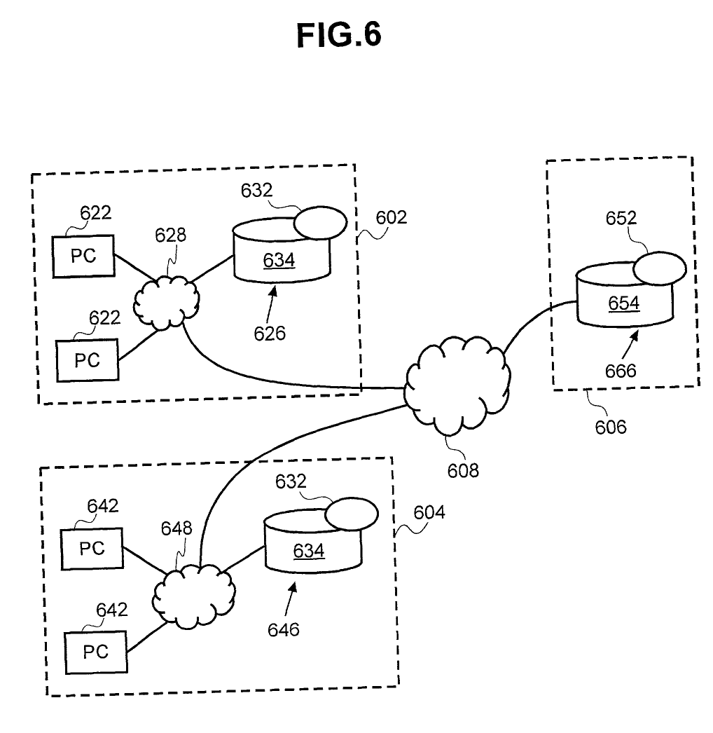

FIG. 6 shows a high level diagram of an illustrative embodiment in connection with a second aspect of the present invention. In the foregoing described aspect of the invention, the hierarchical manager resided in the client site. In this second aspect of the invention, the hierarchical manager, for the most part, is provided at the server site.

Typical client sites (e.g., businesses, individuals, etc.) 602 and 604 each comprises a variety of computer systems 622 and 642 respectively, collectively referred to as PCs. The operating environment contemplated by the present invention is one in which the PCs frequently or at least occasionally need to access some sort of remote storage. The PCs are connected to respective internally provided data communication networks 628, 648.

At each client site 602, 604, some form of storage device 626, 646, respectively, is provided. In an illustrative embodiment of this second aspect of the invention, the storage device is a NAS device, but in general may be other storage architectures. The storage device serves as a locally accessed remote storage system for the PCs at the client sites. Each of the storage devices is of conventional architecture, comprising a controller portion 632 operatively coupled to a data storage portion 634. The controller portion comprises known computer processing technology, typically a computer with appropriate software to provide the necessary operational capabilities to operate as a data server.

The physical composition of the data storage portion 634 can be any of known conventional mass storage data systems. For example, the data storage portion may be any of the known RAID (redundant array of independent disks) class storage systems. The particular storage system type is not pertinent to the practice of the present invention. The operational aspects of the controller portion in accordance with the invention will be described in detail below.

Each of the client sites 602, 604 has access to a data communication network 608 that is external to their operation, e.g. a wide-area network (WAN). This might be a T1 connection, or a higher capacity connection, for example. The specific details of such a data connection are not pertinent to the practice of the invention.

In this second aspect of the invention, a server site 606 provides a remotely accessed storage device 666 which can be accessed over the communication network 608. The illustrated embodiment contemplates a NAS device to be used at the server site as the storage device. However, any appropriately configured storage device can be used. The storage device comprises a controller portion 652 operatively coupled to a data storage portion 654. The controller portion for the storage device 666, similar to the above-discussed storage devices 626, 646, may comprise any conventional computer processing system. However, particular programming code is included in the controller portion 652 for operation in accordance with this second aspect of the invention, as will be discussed below. The data storage portion 654 of the storage device may comprise any conventional appropriate data storage system.

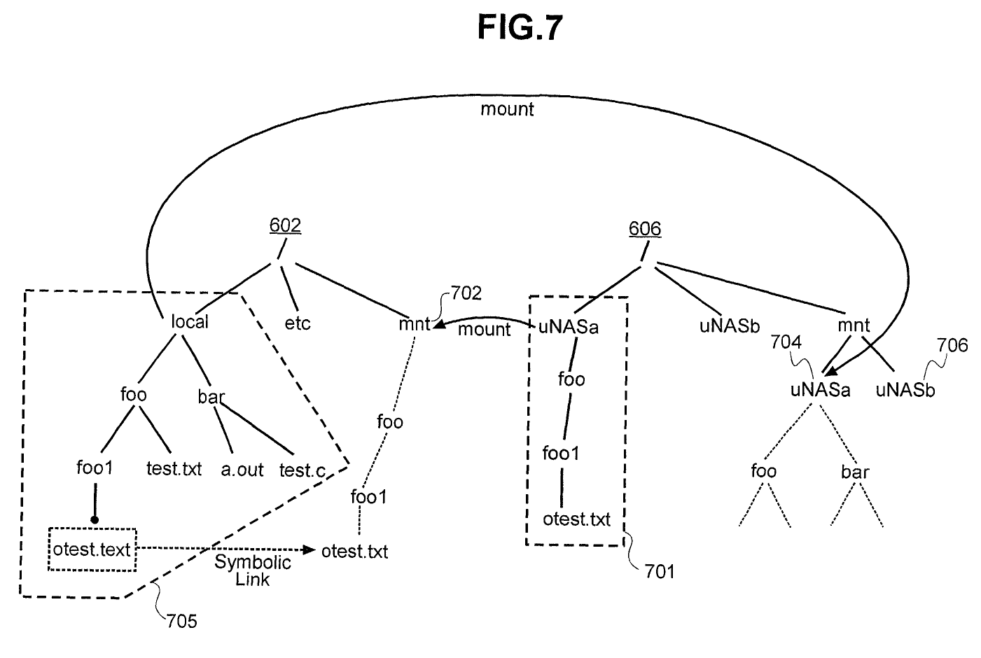

FIG. 7 shows the manipulations to the file systems in both the client sites 602, 604 and server site 606 according to the illustrative embodiment of this second aspect of the invention. The client site mounts a directory tree 701 in the file system of the server site, in the same manner as discussed earlier. More particularly, as shown by the example in FIG. 7, the client site 602 mounts the directory tree ‘/uNASa’ from the server site file system at the mount point 702 (namely, ‘/mnt’) of the client site.

In accordance with this embodiment, an additional mount operation is performed. As can be seen in FIG. 7, the server site mounts a local directory tree 705 of the client site (here, ‘/local’) to its mount point 704 (namely, ‘/mnt/uNASa’). This provides the server site with access to at least a portion of the client site file system, namely, ‘/local’. By convention, all files subject to processing according to this embodiment reside under the directory tree rooted at the directory ‘/local’. It is noted that the directory structure of a particular client site of course can be rooted elsewhere in the filesystem.

FIG. 7 also shows a second mount point 706 ‘/mnt/uNASb’ in the file system of the server site. This second mount point is for use with another client site. Additional mount points can be provided for additional client sites in this manner.

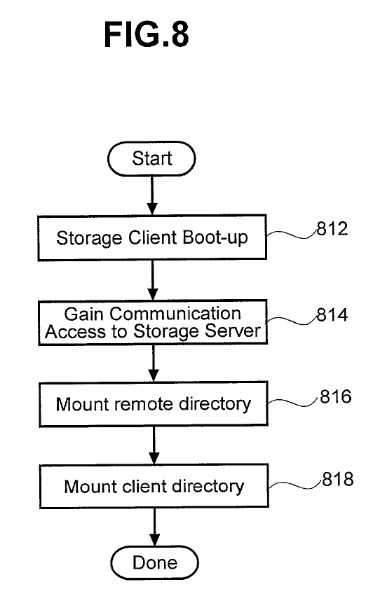

FIG. 8 shows a typical start up sequence for the illustrated embodiment of this second aspect of the invention. The client site 602 (FIG. 6) performs its boot up sequence, step 812. When the client site is online, it establishes communication with the server site 606 (step 814) and gains access to a part of the server site's file system, step 816. Conversely, in accordance with this aspect of the invention, the server site gains access to a part of the client site file system, step 818. In the illustrated embodiment where the systems are UNIX-based (e.g., BSD OS), a mount operation is performed. Thus for example, with respect to FIG. 7, the server site mounts ‘/local’ from the client site onto ‘/mnt/uNASa’ 704. Similarly, the client site mounts “/uNASa” from the server site onto ‘/mnt’ 702.

The processing shown in FIG. 3 for a hierarchical manager resident in the client site also applies in this second aspect of the invention where a hierarchical manager resides at the server site. Processing at the server site in accordance with the flow chart 300 is made possible by the fact that the server site has mounted the file system of the client site. The server site therefore has access to the client site file system and is thus able to monitor and access the client site's file system. When the server site mounts the client site directory, technically the client site becomes “a file server” for the server site. So both the server site and the client site are file servers and clients at the same time.

Referring then to FIGS. 3 and 6, processing begins with the detection of a triggering event at the server site, step 302. The triggering event can be a scheduled event wherein storage management is performed periodically. The triggering event can be initiated by a system level process on a demand basis. For example, a system administrator at the server site may initiate the process manually. The triggering event might even be initiated by non-system administration user, though typically not permitted in a computing facility. A preventative measure such as detection of a near-full condition (e.g., 90% utilization of the total capacity of the disk might be used as a triggering threshold value) could serve as a triggering event which initiates the process. For example, the server site may run a “cron” process that could execute periodically to check the available disk space of the client site, and initiate the process if the available disk capacity falls below a predetermined threshold value. The server site is able to do this since it has mounted the directory tree of the client site and thus has access to information about the available disk space of the client site. For example, in the BSD embodiment, executing the ‘df’ system utility on the mount point (e.g., /mnt/uNASa, 704) will provide information such as what percentage of disk space of the filesystem (i.e., /local, 705) is consumed. Since the server site provides offsite storage facilities for plural client sites, the triggering event must be associated with the client site.

In response to the triggering event for a given client site, a master list of the files that should be “moved” from that client site to the server site 606 is produced. In the illustrated embodiment of this second aspect of the invention, such a list is created by the server site, first by producing a first list which lists (i.e., names) all of the files in the local file system of the client site, step 302. Those files in the first list that are in fact symbolic links are removed from the first list, step 304; there is no need to process those files that are symbolic links, since such files consume no storage space in the local file system.

Those files listed in the first list that are also listed in an “upper list” are removed from the first list, step 308. This “upper list” is maintained at the server site and names those files in the client site which a priori have been deemed should not be moved to the server site 606. Upon filtering the first list with the “upper list”, a second list (i.e., the master list) results which contains only those files that should be moved to the server site. The “upper list” can be modified at any time, including deletions, and so the foregoing filtering step should be performed each time when the triggering event is detected.

Files listed in a “lower list” are moved to the server site 606, step 310. The “lower list” specifies those files which have been deemed (e.g. by the system administrator and/or users) to always be stored at the server site. This is ensured by performing this step each time the trigger event is detected. As with the “upper list”, the “lower list” can be modified.

Next, files in the “upper list” are moved from the server site to the client site, step 312. This action guarantees that those files listed in the “upper list” are in fact physically located at the client site.

After the files listed in the “lower list” and the “upper list” have been moved accordingly, the files in the master list are moved one at a time from the client site 602 to the server site 606. This is repeated for each file until the available disk capacity increases above a predetermined threshold, say 20% for example, step 313. The least recently accessed files are moved first (step 314), since they represent the least active files. For each file that is moved to the server site, a symbolic link is created in the client site, as previously discussed, step 316.

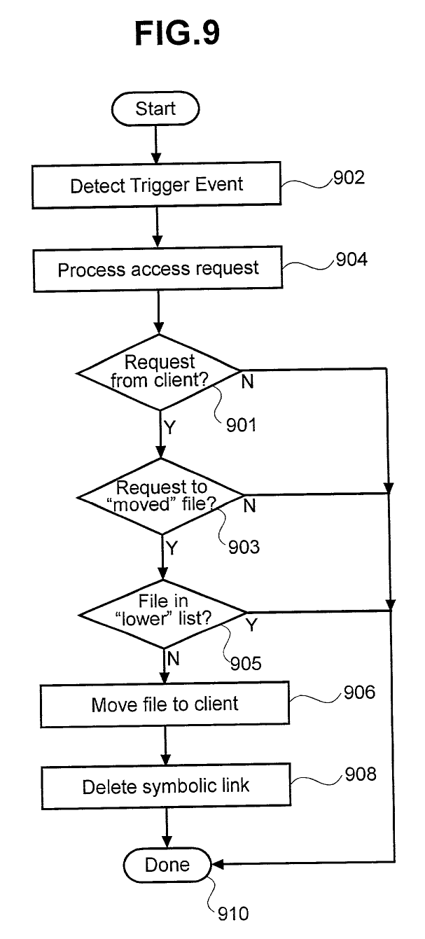

Referring to FIG. 9, another aspect of the hierarchical manager is shown according to this second aspect of the invention. Here, the trigger event (step 902) is a file access request made at the client site for a file that had previously been moved to the server site. Since the server site has mounted the client site directory tree, the detection of such an event is made possible when a file is accessed via the symbolic link. In BSD OS, when a read request for a symbolic link is issued to the client site, the client site issues a read request to the server site. The server site traps this file request from the client site. As noted above, trapping file I/O requests can be accomplished by making appropriate modifications to the filesystem at the server site.

Upon detecting a file access trigger event from the client site, the access request is performed, step 904. Next, after the file access has been serviced, a first decision point, step 901, is performed to determine whether the file access was from the client site. If not, then processing is complete, step 910. If step 901 is affirmative, then a second decision point, step 903, determines whether the file access request from the client site was to a file that had been moved to the server site from the client site. This is done by determining if the file being accessed is located in the local directory (at the server site) associated with the client site. For example, FIG. 7 shows that client site 602 has an associated local directory in the server site 606 named ‘/local/uNASa’. Thus, if the file is located somewhere below ‘/local/uNASa’, then the decision point at step 903 is affirmative and processing proceeds to the next decision point, step 905. If not, then the file access was to a file that should remain at the server site, and processing is complete, step 910.

At decision point 905, a check is made to determine whether the accessed file is listed in the “lower list”. If so, that indicates the file had been deemed to remain at the server site, and so processing completes, step 910. Otherwise, the file is copied back to the client site, step 906, which includes deleting the file at the server site. Also, the symbolic link at the client site is replaced with reference to the physical file which now resides at the client site, step 908.

As with the first aspect of the invention, this second aspect of the invention is readily adapted in an SSP environment. Storage can be allocated to a client and charged on a per use basis. Thus, the client is billed according to the amount of storage consumed. For example, in a monthly billing plan, an average storage consumption rate can be computed. The client would then be billed based on the average. In another billing plan, the client may be billed according to the maximum physical storage used during a period of time.

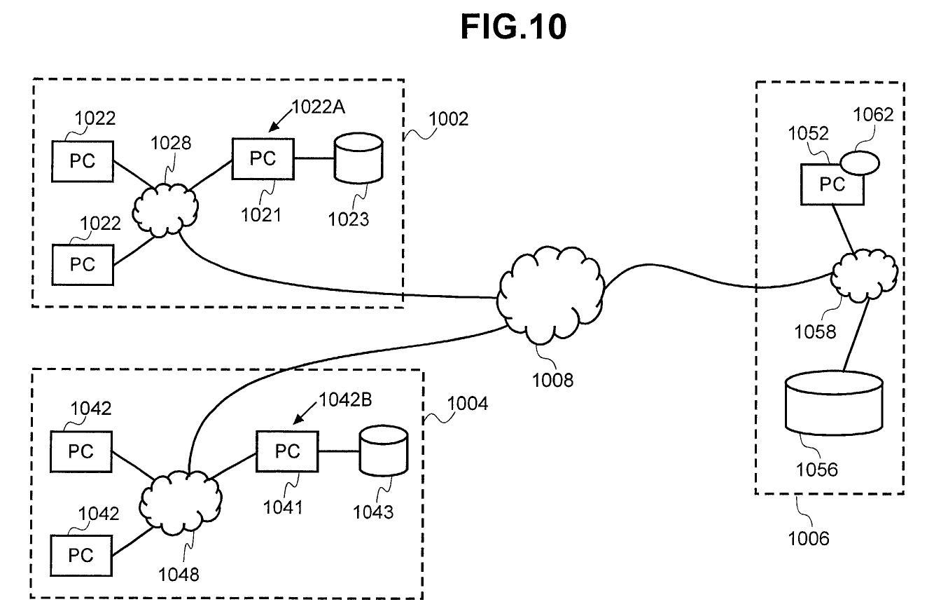

FIG. 10 shows a high level diagram of an illustrative embodiment of a third aspect of the present invention. Typical client sites 1002 and 1004 are shown, each comprising a variety of computer systems 1022 and 1042 respectively, collectively referred to as PCs. In a contemplated operating environment for this third aspect of the invention, each computer system, e.g., 1022A, 1042B, comprises its own PC computer unit subsystem 1021, 1041 respectively, and accesses its own local storage device 1023, 1043 respectively. The PCs can be connected to respective internally provided data communication networks 1028, 1048.

Each of the data communication networks 1028, 1048, has access to a common data communication network 1008 that is external to their operation, e.g. a wide-area network (WAN). This might be a TI connection, or a higher capacity connection, for example. In a contemplated application of this embodiment, the data communication network 1008 is a corporate backbone in a large corporate environment, linking together smaller offices (e.g., client sites 1002, 1004).

A server site 1006 provides a remotely accessed storage facility. In the corporate setting, for example, the server site might be a computing center for the corporation. The server site comprises a PC 1052, and in accordance with this third aspect of the invention, the PC runs a version of the hierarchical manager 1062. The PC is connected to a local area network (LAN) 1058. One or more data storage systems 1056 are connected to the LAN, providing high capacity remote storage capability. In one embodiment, the data storage systems is a NAS device, but can be some other suitable storage facility.

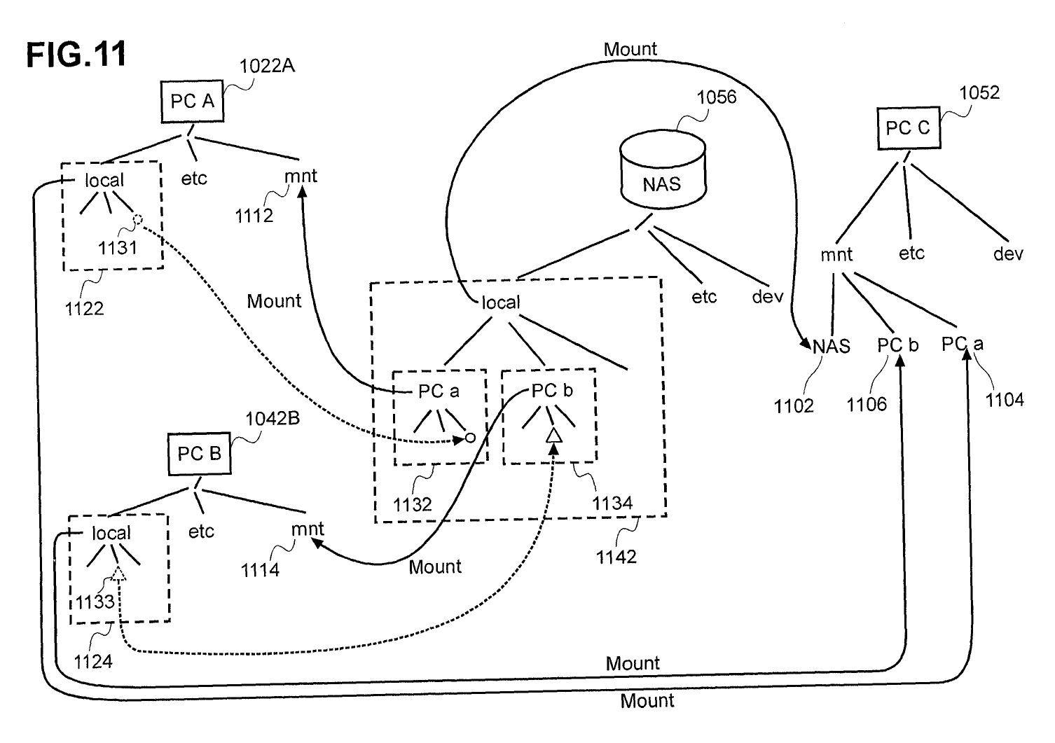

FIG. 11 shows the file system manipulations according to this illustrative embodiment of the third aspect of the invention. Each device, including PC's 1022A, 1042B, 1052 and storage device 1056, has its own file system. The communication networks 1008 and 1058 shown in FIG. 10 allow the file systems to perform the mount operations indicated in FIG. 11.

In particular, PC A (1022A) comprises a local file system having a local directory tree 1122. By convention, all user files created in PC A are stored under the directory tree 1122. Similarly, PC B (1042B) comprises a local file system having a local directory tree 1124. Also by convention, all user files created in PC B are stored under the directory tree 1124. The local file system of each PC also contains the common system directories normally found in a UNIX-based OS.

At the server site 1006, the file system in the remote storage device 1056 includes a local directory tree 1142. Under this directory tree are two sub-trees named ‘/local/Pca’ (1132) and ‘/local/Pcb’ (1134). The sub-tree 1132 is mounted by PC A (1022A) at a mount point 1112 (‘/mnt’) in the PC A file system. Likewise, the sub-tree 1134 is mounted by PC B (1042B) at a mount point 1114 (‘/mnt’) in the PC B file system.

FIG. 11 shows that a file 1131 in PC A (1022A) has been moved to the remote storage device 1056, in accordance with the third aspect of the invention which will be described below. Accordingly, the physical location of the file is located in the remote storage device. The filename of the moved file occupies a corresponding location in the sub-tree 1132 of the remote storage device associated with PC A. Furthermore, a symbolic link is created in PC A which replaces the filename of the moved file. This is represented in FIG. 11 by the dashed arrow. Similarly, a file 1133 in PC B (1042B) is shown to have been moved, also in accordance with the third aspect of the invention. The physical file is located in the remote storage device 1056. A symbolic link is created in PC B to the file in the remote storage device.

FIG. 11 also shows that PC C (1052) includes three mount points 1102 (‘/mnt/NAS’), 1104 (‘/mnt/Pca’), and 1106 (‘/mnt/PCb’). These mount points are for mounting various directory trees in the file systems of the remote storage device 1056, PC A (1022A), and PC B (1042B), respectively. In particular, PC C mounts the ‘/local’ directory tree 1142 of the remote storage device to mount point 1102. Similarly, the ‘/local’ directory trees 1122, 1124 of PC A and PC B, respectively, are mounted to mount points 1104 and 1106, respectively.

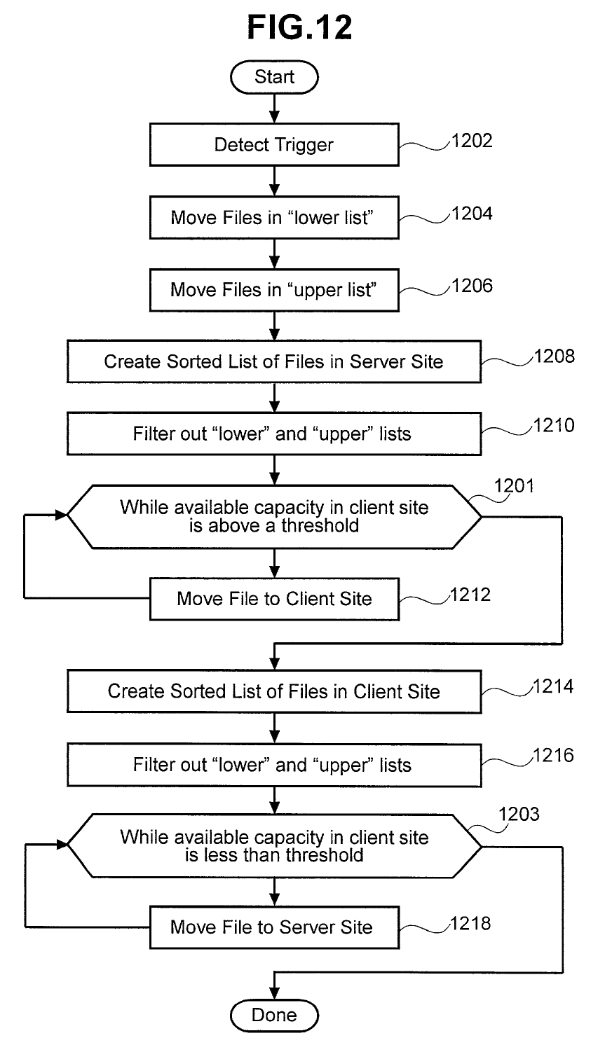

Refer now to FIG. 12 for a discussion of the processing in the hierarchical manager 1062 (FIG. 10) according to the illustrative embodiment of this aspect of the invention. Processing begins with the detection at the server site 1006 of a triggering event, step 1202. A triggering event may simply be the passage of a fixed amount of time, during a scheduled maintenance procedure for example. A triggering event might be the detection of a low available storage space condition. This could be provided by running a “cron” process wherein the server site periodically checks the available storage of its client sites 1002, 1004. The triggering event could be an explicit request from a system administrator at the server site. Since the server site handles plural clients, the triggering event is associated with information identifying the client to which the triggering event is associated.

In response to the triggering event, the hierarchical manager consults a “lower list” containing a list of filenames of files which have been decided should be physically stored on the server site, step 1204. Each such file is moved to the server site which had not already been moved to the server site. The atime parameter of each moved file is adjusted to reflect its time value just prior to the move operation. Recall that the move operation from the client site to the server site includes: making a copy of the file on the server site, deleting the file from the client site, and replacing the filename in the client site with a symbolic link.

Next, in step 1206, an “upper list” is consulted. This list contains filenames of files which have been deemed should always reside in the client site. Thus, for each file that is not already in the client site, it is moved from the server site to the client site. The atime parameter of each moved file is adjusted to reflect its time value prior to the move operation. Recall that the move operation from the server site to the client site includes: making a copy of the file at the client site, replacing the symbolic link at the client site with the actual filename, and deleting the file at the server site.

In step 1208, a list of files that had been moved from the client site to the server site which now reside on the server side is created. The list is sorted according to the atime parameters of the files. The files identified in the “lower list” and the “upper list” are filtered (or otherwise excluded) from this sorted list, step 1210. Next, each file in the sorted, filtered list is moved from the server site to the client site, step 1212. More specifically, those files which have been most recently accessed by the client are moved. This is facilitated by the fact that the list is sorted by the atime parameter. Step 1212 continues until the available disk capacity in the client site falls below a predetermined threshold, step 1201. For example, files can be moved back to the client until there is only 5% available space remaining on the client side.

Next, in step 1214, a list of files which reside on the client side is created and sorted by atime. The list is filtered using the “upper” and “lower” lists, step 1216. The list is further filtered to remove (or otherwise exclude) those filenames which are actually symbolic links. In fact, the “lower list” files will have already been moved in step 1204 to the server site and so those filenames will have been replaced with symbolic links. Each file in the sorted, filtered list is moved from the client site to the server site, step 1218. More specifically, those files which have been least recently accessed are moved first. This is facilitated by the fact that the list is sorted according to the atime parameter. Step 1218 continues until the available disk capacity reaches a predetermined threshold, step 1203. For example, files can be moved down to the server side until the available capacity on the client side reaches 20% or so.

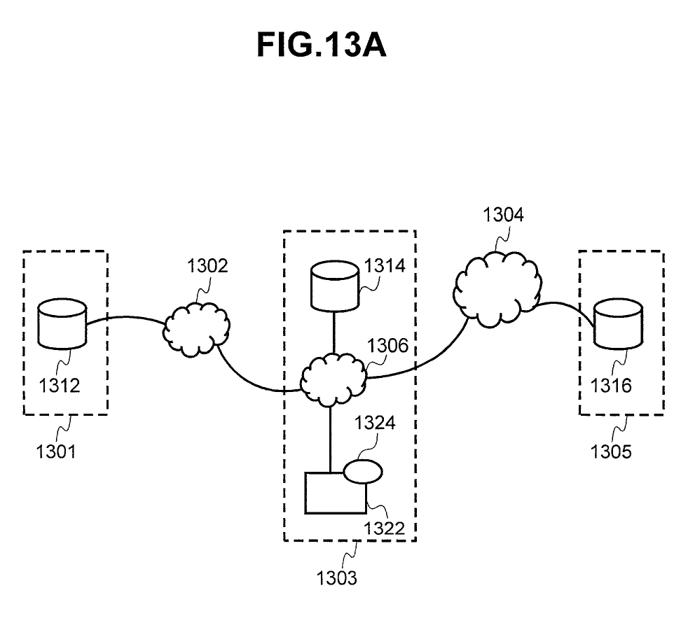

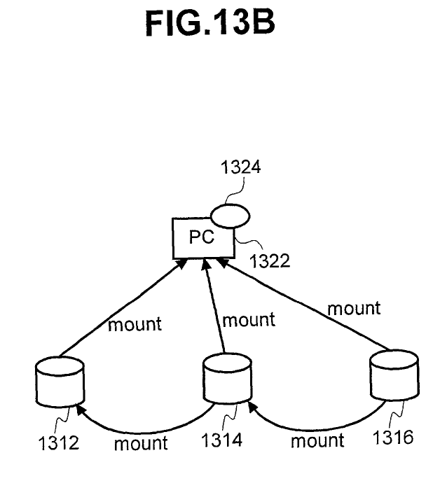

Refer now to FIGS. 13A and 13B for an illustrative embodiment of a fourth aspect of the present invention. FIG. 13A shows a storage facility 1303 connected to a communication network 1306. The storage facility includes a data storage device 1314, such as a NAS device for example. The storage facility also includes a computer system 1322 containing a hierarchical manager 1324 operating in accordance with this embodiment of the invention is also connected to the communication network 1306. Another storage facility 1301 is connected to a communication network 1302, and includes a storage device 1312. Still another storage facility 1305 is connected to still another communication network 1304, and includes a storage device 1316. The communication network 1306 has communication links to the other two communication networks 1302, 1304.

The architecture shown in FIG. 13A can be the environment of any computing facility such as a corporation, an engineering company, an educational setting, and so on. In a corporate setting, for example, the storage facility 1301 might comprise a small network of PC's in an office environment, linked together by a LAN. A NAS device might be the central data store 1312 of the storage facility 1301. The communication network 1302 would be the corporate network backbone of the company. The storage facility 1303 might be a central computing center for the entire company, comprising PC's and a central storage device 1314. The computer system 1322 is a computer in the central computing facility which provides the storage management capabilities according to this aspect of the invention. The communication network 1306 is a LAN within the central computing center, providing the computer system 1322 access to the central data storage 1314 of the storage facility 1303. The storage facility 1305 could be a storage service provider (SSP), providing high capacity data storage for the corporation. In this setting, the communication network 1304 would be a wide area network (WAN). The storage device 1316 could be some form of high capacity storage system.

FIG. 13B shows the interrelationship of the file systems among the components illustrated in FIG. 13A. As in the other embodiments, this embodiment is based on a UNIX-type OS (e.g., BSD OS). Thus, according to this fourth aspect of the invention, the computer system 1322 mounts portions of each of the file systems contained in the storage devices 1312, 1314, 1316. In addition, the file system in the storage device 1312 mounts a portion of the file system in the storage device 1314. The file system in the storage device 1314, in turn, mounts a portion of the file system in the storage device 1316. For the discussion which follows, the following naming convention will be used: the storage device 1312 is referred to as the upper storage device; the storage device 1314 is referred to as the middle storage device; and the storage device 1316 is referred to as the lower storage device.

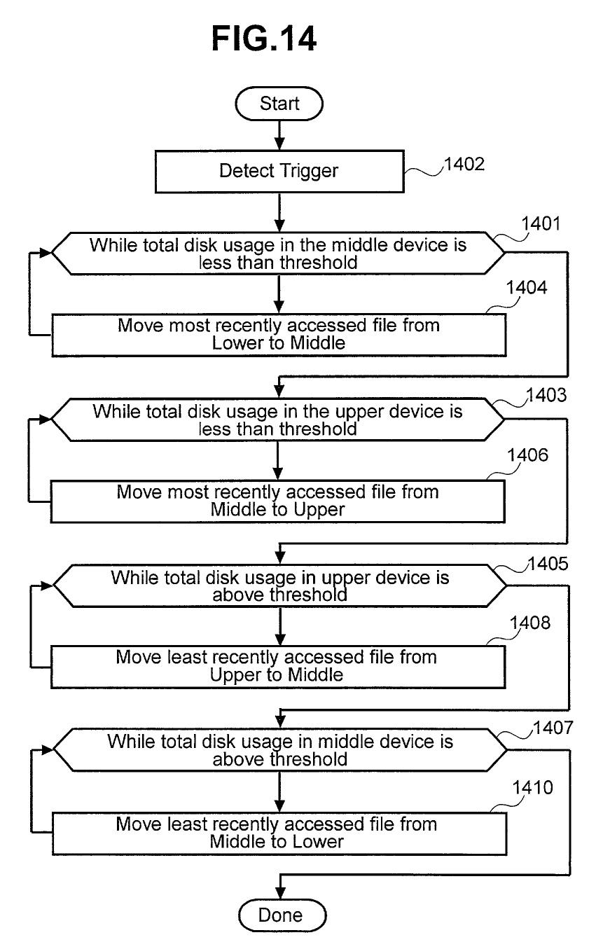

FIG. 14 outlines the processing which occurs in the hierarchical manager 1324 in accordance with an illustrative embodiment for this fourth aspect of the invention. Generally, an intermediate storage device (middle storage device) provides storage management for an upper storage device in accordance with this fourth aspect of the invention. Files are moved from the upper storage device to the intermediate storage device. A lower storage device provides storage management for the intermediate storage device in accordance with this fourth aspect of the invention.

Processing is initiated by detecting a trigger event, step 1402. The triggering event may be a scheduled event to perform storage management, or the detection that the available disk capacity in the upper storage device 1312 decreases below some predetermined threshold (or conversely, that a percentage of the total capacity of the storage device has been allocated for files), or the detection that the available disk capacity in the middle storage device 1314 decreases below some predetermined threshold value. The triggering event can be an explicit event initiated by a system administrator.

Next, files are moved from the lower storage device 1316 to the middle storage device 1314, step 1404. The files that are moved are those files which had been previously moved from the upper storage device 1312 via the middle storage device, as will be shown, to the lower storage device (i.e., those files which originally were stored in the upper storage device). More specifically, the most recently accessed files are moved. Enough files are moved from the lower storage device to the middle storage device so that the disk usage in the middle storage device exceeds a threshold value, step 1401.

Thus, for steps 1401 and 1404, in accordance with the illustrated embodiment of this aspect of the invention, a list of files are created and sorted according to their atime parameter. A middle list and a lower list can be provided, similar to the upper and lower lists discussed above. These lists could be used to filter out (or otherwise exclude) those files which have been deemed to remain in the middle storage device 1314 (middle list) or in the lower storage device 1316 (lower list). Files in the sorted (and perhaps filtered) list is copied from the lower storage device to the middle storage device, one at a time until the disk usage in the middle device exceeds the threshold. The most recently accessed files are moved first. This can be achieved, for example, by sorting the files in descending order of the atime parameter and moving each file beginning from the top of the list. For each file moved from the lower device to the middle device, it is deleted from the lower device and the symbolic link in the middle device is replaced with reference to the file itself in the middle device. Also, the atime parameter of the moved file is set to the value it had when the file physically resided in the lower storage device; i.e., the atime parameter is set to the value it had prior to the operation.

In steps 1403 and 1406, similar processing occurs between the middle storage device and the upper storage device as takes place in steps 1401 and 1404 between the lower storage device and the middle storage device. The files that are moved are those that had been previously moved from the upper storage device to the middle storage device; i.e., those files which originally were stored in the upper storage device.

Next, in steps 1405 and 1408, files are moved from the upper storage device 1312 to the middle storage device 1314. More specifically, the least recently accessed files are moved. For each file moved from the upper device to the middle device, a logical reference is created in the upper device file system in place of the original filename.

In terms of the illustrated embodiment for this aspect of the invention, step 1408 comprises creating a sorted list of the files in the upper device file system. Excluded from this list are filenames that are in fact symbolic links. Also excluded are those files which have been deemed to remain resident in the upper storage device. This is accomplished as explained in earlier embodiments by filtering the sorted list with an upper list which contains those files which should not be moved from the upper storage device. The list is sorted by the atime parameter, in ascending order. Each file in the sorted (and optionally filtered) list is moved, one at a time beginning from the top of the list. In this way, the least recently accessed files are moved first. This continues, until the available disk capacity reaches a predetermined threshold. For each file moved, a copy of the file is created in the middle device, the file is deleted from the upper device, and a symbolic link replaces the filename in the upper device; the symbolic link being to the file now located in the middle device. The atime parameter for each moved file is adjusted to be the value it had just before being moved.

Processing for steps 1407 and 1410 proceeds in the same manner between the middle storage device and the lower storage device as in steps 1405 and 1408 between the upper storage device and the middle storage device. The files that are moved from the middle device to the lower device are those files which had previously been moved from the upper device to the lower device.

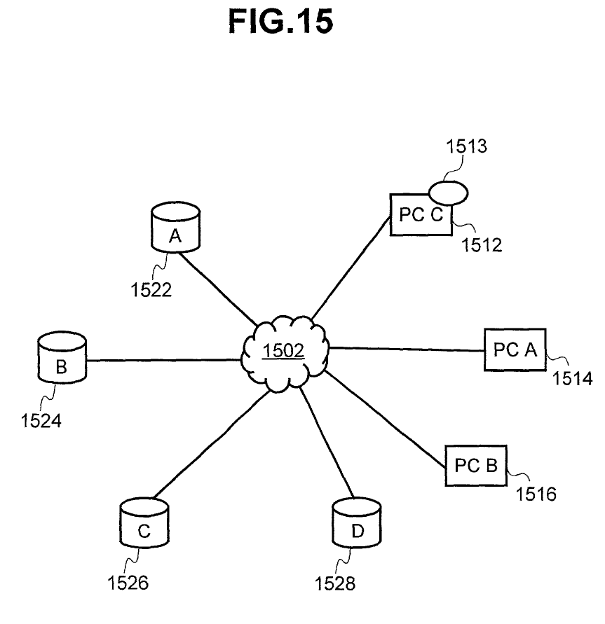

Refer now to FIG. 15 for a discussion of an illustrative embodiment of yet a fifth aspect of the present invention. In accordance with the fifth aspect of the invention, plural storage devices are provided. A hierarchical manager having access to the storage devices moves files among the storage devices depending on available storage capacity of each device. The illustrative embodiment of FIG. 15 shows plural storage devices 1522-1528 (designated A-D, respectively). Plural PCs 1514, 1516 (designated PC A and PC B, respectively) are shown illustrating the users of one or more of the storage devices. A PC 1512 (PC C) includes a hierarchical manager 1513. A communication network 1502 is shown providing communication access among the devices. According to this aspect of the invention, it is noted that PC C (1512) has access to at least portions of the file systems of each of the storage devices A-D. Similarly, in according with this aspect of the invention, each of the storage devices A-D has access to at least portions of the file systems of the other storage devices. User access by other PCs in this architecture (e.g., PC A, PC B) may have any combination of access to the storage devices. Consequently, the communication network 1502 represents generally that there is some form of data communication path among the devices, and for any particular embodiment the communication network may comprise combinations of LAN's, WAN's, and so on.

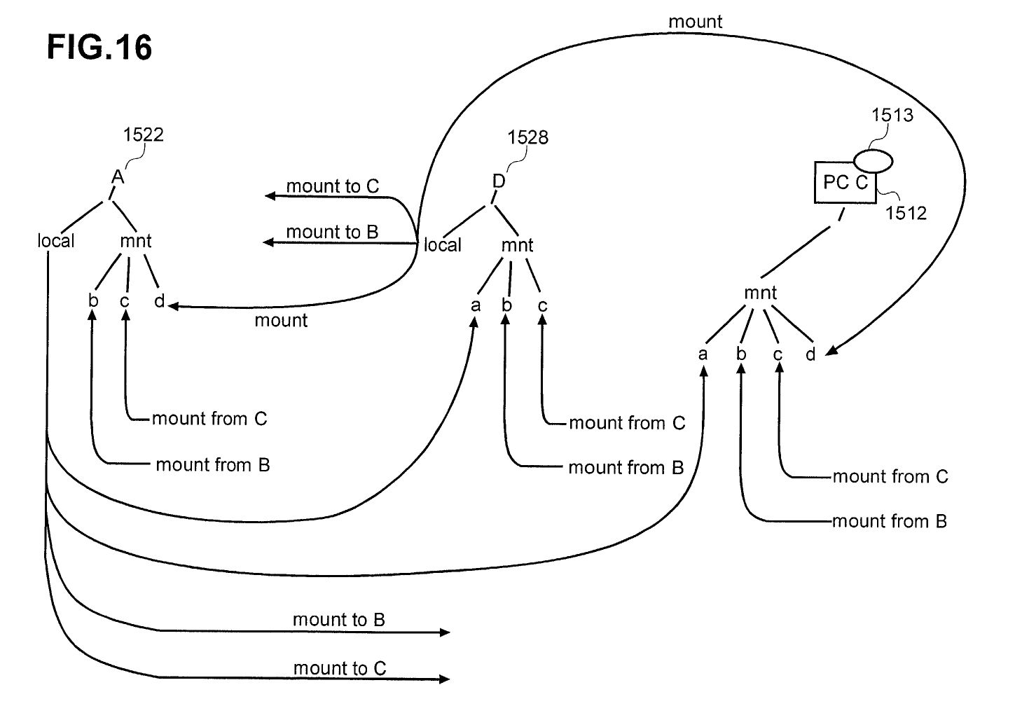

FIG. 16 illustrates the interrelationship among the file systems according to this fifth aspect of the invention. Generally, each storage device 1522-1528 is provided with access to a portion of the file systems of the other storage devices. Further, the PC C (1512) has access to at least a portion of the file system of each storage device. FIG. 16 shows this in connection with the illustrative embodiment of this aspect of the invention. Thus, it can be seen that storage device A 1522 mounts a directory tree (e.g., ‘/local’) from each of storage devices B (1524), C (1526), and D (1528), respectively at mount points ‘/mnt/b’, ‘/mnt/c’, and ‘/mnt/d’ of the file system in device A. FIG. 16 further illustrates that storage device D 1528 mounts the directory tree ‘/local’ from each of storage devices A (1522), B (1524), and C (1526), respectively at mount points ‘/mnt/a’, ‘/mnt/b’, and ‘/mnt/c’ of the file system in device D. Storage devices B and C each is treated in a similar manner. Additionally, PC C (1512) mounts the ‘/local’ directory tree of each of the storage devices A-D since the hierarchical manager resides there. Furthermore, it is noted that PC C itself can include a storage device E (not shown) that is just another one of the plural storage devices A-D.

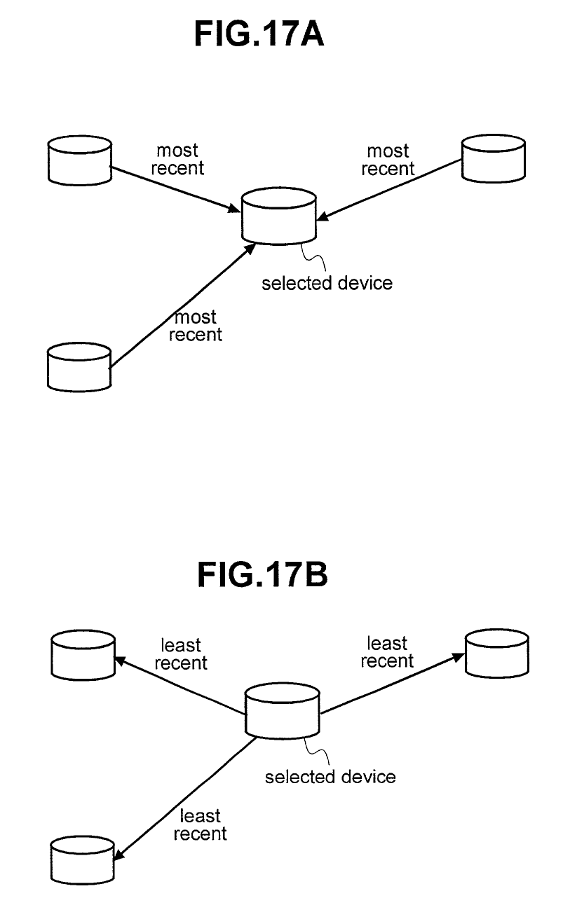

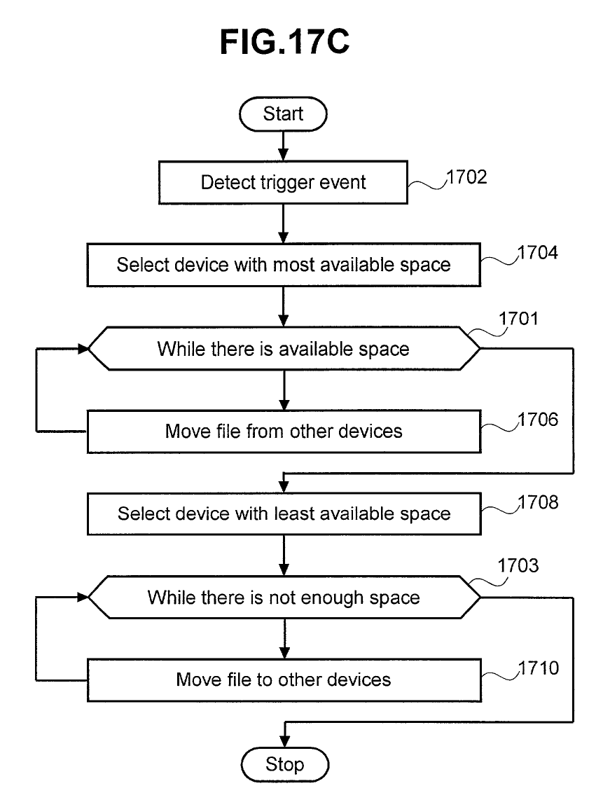

FIGS. 17A and 17B illustrate the processing according to this fifth aspect of the invention. As can be seen in FIG. 17A, a first part of the processing involves moving files to a storage device with the most available disk capacity which is designated as a “selected device.” Files from the other devices are moved to the selected device. FIG. 17B shows the second part of the processing, where the storage device with the least available disk capacity is designated as the “selected device.” Its files are moved to the other storage devices.

FIG. 17C is a flow chart illustrating the process steps in accordance with the illustrative embodiment of this fifth aspect of the invention. A triggering event is detected the hierarchical manager 1513 in the PC C (1512), step 1702, to begin the process. The triggering event can be a scheduled maintenance-type event, e.g., occurring once a week. The triggering event can be based on detecting that one of the storage devices is “almost full,” e.g., 95% of the total disk capacity of that storage is allocated to files. The triggering event can be explicitly triggered by a system administrator.

When the triggering event occurs, processing begins with the hierarchical manager identifying the storage device having the most available disk capacity by accessing the mounted directories trees in the file system of PC C (15 12), step 1704. A storage device (A-D) having the most available disk capacity is designated as the “selected device.” For this part of the processing, the “selected device” refers to the storage device from which files will be moved.

Files are moved back to the selected device from the other storage devices (“the non-selected devices”). This is explained with respect to the steps 1701 and 1706 shown in FIG. 17C. A list of files is produced of those files that had previously been moved from the selected device to the non-selected devices; i.e., those files which originally belonged to the selected device. This part of the processing works to bring those files back to their place of origin, in the selected device. As explained already, files moved from a file system in accordance with the illustrated embodiments of the invention are replaced with symbolic links. Thus, the list is readily produced by looking in the selected device for filenames which are symbolic links.

The list is sorted by the atime parameter in descending order, the top of the list therefore representing the most recently accessed file. Beginning from the top of the list, each file is copied from the storage device on which it is physically located to the selected device. After the copy operation, the physical file is deleted from the storage device (a non-selected device) from which it was copied, thus releasing storage space in that storage device. The filename of the moved file now becomes a symbolic link. This continues until the percentage of total storage capacity of the selected device utilized for files increases above a threshold value. Thus according to this illustrative embodiment of this fifth aspect of the invention, the most recently accessed files in the selected device are returned to the selected storage device.

In the second part of processing, a storage device having the least available free space is selected from among the storage devices, step 1708. For this part of the processing, the “selected device” refers to the storage device having the least available free space. As will be seen, the selected device now refers to the storage device from which files are moved. The storage devices other than the selected device are referred to as the “non-selected devices.”

Files are moved from the selected device to the non-selected devices as indicated in steps 1703 and 1710 of FIG. 17C. A list of files in the selected device is produced. This list identifies actual files stored in the selected device. Those files which are symbolic links are excluded, since such files have already been moved from the file system of the selected device. Also, those files which are deemed to remain in the selected device are removed (filtered, or otherwise excluded) from the list. Such files might be maintained in an “upper” list.

Next the list is sorted by the atime parameter in ascending order, the top of the list therefore being the least recently accessed file. Beginning from the top of the list, each file is copied to a non-selected device. In accordance with the illustrative embodiment of this fifth aspect of the invention, the non-selected storage device to which the file is moved is chosen in round-robin fashion. In a variation of the illustrative embodiment, the choice can be based on criteria such as available free space for example. Each file that is copied from the selected device to a non-selected device is deleted from the selected device and replaced with a symbolic link to the non-selected storage device where it now physically resides. This continues until the available free space on the selected device increases to a predetermined threshold.

The foregoing disclosed aspects of the invention facilitate storage space management in a data storage system. The various embodiments provide storage space management in a transparent manner by moving files as needed between client and an off-site storage server, and in other embodiments among storage sites. By targeting those files which are used less frequently, the requirements for off-site storage are kept low.

From the foregoing, it will be apparent that an improved storage management method and system has been provided. Variations and modifications of the disclosed illustrative embodiments and additional applications of the present invention will no doubt suggest themselves to those skilled in the relevant arts. Accordingly, the foregoing discussions should be considered as illustrative and not in a limiting sense.

What is claimed is:

1. A data storage method comprising:
copying one or more files contained in a first storage device to create corresponding files in a second storage device, the first storage device located at a first site, the second storage device located at a second site different from the first site;
deleting the one or more files from the first storage device to recover storage space occupied by the one or more files and thus increase the available storage capacity of the first storage device;
detecting an occurrence of an access request to a first file of the one or more files; and
subsequent to the step of detecting, copying the file corresponding to the first file from the second storage device to the first storage device and deleting the corresponding file from the second storage device.

2. The method of claim 1 further including creating a logical reference in the first storage device to each of the corresponding files in the second storage device, the access request to the first file being an access request on the logical reference associated with the first file.

3. The method of claim 1 further including setting last-access-time parameters of the corresponding files equal to last-access-time parameters of the one or more files.

4. The method of claim 1 wherein the number of the one or more files deleted is sufficient to increase the available storage capacity of the first storage device to a predetermined threshold value.

5. The method of claim 1 wherein the first step of copying and the step of deleting are performed in response to detecting that files stored on the first storage device consume a predetermined percentage of the total capacity of the first storage device.

6. The method of claim 1 wherein the one or more files are selected from a plurality of files stored on the first storage device, the plurality of files exclusive of files deemed to remain on the first storage device, the one or more files being the least recently accessed files of the plurality of files.

7. The method of claim 1 further including servicing the access request subsequent to performing the second step of copying.

8. The method of claim 1 further including servicing the access request prior to performing the second step of copying.

9. A storage server site having a server computer system operable according to the method of claim 1 to provide storage service for a client, the server computer system comprising: a data storage system for use by the client and means for generating a request for payment in connection with the client's use of storage space on the data storage system.

10. A data storage method comprising:
moving at least a first file from a client file system to a server file system, including producing a duplicated first file at the server file system, setting a last-access-time information associated with the duplicated first file equal to a last-access-time information associated with the first file, deleting the first file from the client file system thus increasing an available storage capacity of the client file system, and producing in the client file system a logical reference of the first file, the logical reference effective so that users at the client file system can access the first file though the first file has been deleted from the client file system;
detecting a file access request of the first file; and
in response to detecting the file access request, copying the duplicated first file at the server file system to the client file system to reproduce the first file, setting the last-access-time information of the first file equal to the last-access-time information of the duplicated first file, deleting the duplicated first file from the server file system, replacing the logical reference at the client file system with a file reference to the first file at the client file system.

11. The method of claim 10 wherein the step of moving includes moving additional files from the client file system to the server file system in addition to the first file, wherein the number of additional files is sufficient to increase the available storage capacity to a predetermined threshold.

12. The method of claim 11 wherein the step of moving is performed in response to detecting that a predetermined percentage of the total storage capacity of the client file system has been allocated for files.

13. The method of claim 11 wherein the additional files are selected from a list of files that is sorted in order from earliest access time to most recent access time so that the additional files constitute the least recently accessed files.

14. The method of claim 10 wherein the client file system and the server file system each is a UNIX-type file system.

15. The method of claim 14 wherein the logical reference is a symbolic link.

16. The method of claim 10 as used by a storage service provider (SSP), the SSP providing the server file system, the SSP requesting payment based on the amount of storage allocated to files copied from the client file system.

17. A method for data storage management between a first storage system and a second storage system comprising:
copying a first plurality of one or more files from the second storage system to create corresponding first files in the first storage system, the first plurality of files having been previously copied from the first storage system, the number of files in the first plurality of files being such that an amount of storage space used in the first storage system increases above a first threshold value;
deleting the first plurality of files from the second storage system;
copying a second plurality of one or more files from the first storage system to create corresponding second files in the second storage system, the number of files in the second plurality of files being such that the available storage capacity in the first storage device increases above a second threshold value; and
deleting the second plurality of files from the first storage system to increase the available storage capacity in the first storage system, including creating logical references in the first storage system which associate the second plurality of files to their corresponding files in the second storage system so that the files can be referenced through the first storage system even though they have been deleted from the first storage system.

18. The method of claim 17 further including setting last access times of the corresponding first files equal to last access times of the first plurality of one or more files and setting last access times of the corresponding second files equal to last access times of the second plurality of one or more files.

19. The method of claim 17 wherein the first plurality of one or more files comprises files from a set of files stored on the second storage system, the set of files being files which had been previously copied from the first storage system, the first plurality of one or more files being the most recently accessed files in the set of files.

20. The method of claim 19 wherein the set of files are exclusive of files stored on the second storage system that have been determined should remain in the second storage system.

21. The method of claim 17 wherein the second plurality of one or more files comprises files from a set of files stored on the first storage system, the second plurality of one or more files being the least recently accessed files in the set of files.

22. A computer program product for data storage management between a client file system in a first storage system and a server file system in a second storage system comprising:
one or more computer readable media having contained thereon computer program code suitable for being executed on a computer,
the computer program code comprising:
first executable code effective for operating the computer to copy a plurality of one or more files from the client file system to the server file system thus creating a plurality of corresponding files in the server file system;
second executable code effective for operating the computer to delete the plurality of one or more files from the client file system thus recovering storage space in the first storage system occupied by the plurality of one or more files;
third executable code effective for operating the computer to create logical references in the client file system which provide access to the plurality of corresponding files so that the plurality of one or more files can be referenced through the client file system though they have been deleted from the client file system;
fourth executable code effective for operating the computer to detect an access request to a first file of the plurality of one or more files; and
fifth executable code effective for operating the computer to respond to the access request by operating the computer to access its corresponding file in the server file system.

23. The computer program product of claim 22 wherein the computer program code executes on a computer associated with the client file system.

24. The computer program product of claim 22 wherein the computer program code executes on a computer associated with the server file system.

25. The computer program product of claim 24 wherein detecting an access request of the first file includes receiving a server access request to the corresponding file in the server file system via the logical reference associated with the first file and detecting the server access request.

26. The computer program product of claim 22 wherein the first executable code is further effective for operating the computer to set last-access-time parameters of the corresponding files equal to last-access-time parameters of the one or more files.

27. The computer program product of claim 22 wherein the fifth executable code is effective for operating the computer to access the corresponding file by copying the file from the server file system back to the client file system.

28. The computer program product of claim 22 wherein the plurality of one or more files is selected from a list of candidate files and constitute the least recently accessed files of the candidate files, the plurality of one or more files comprising only enough files so that an available storage capacity of the first storage system increases above a predetermined threshold.

29. The computer program product of claim 22 further including sixth executable code effective for operating the computer to detect when an available storage capacity of the first storage system decreases below a predetermined threshold, and in response thereto to cause execution of the first, second, and third program codes.

30. The computer program product of claim 22 wherein the computer program code is suitable for execution in a UNIX-based operating system, the computer program code further including executable code effective for operating the computer to mount a directory tree in the server file system onto the client file system, thus providing access between the client file system and the server file system.

31. The computer program product of claim 30 wherein the logical reference of each of the one or more files is a symbolic link to its corresponding file in the server file system.

32. A data storage management computer operable to provide data storage for a client storage system having a client file system comprising:
a data storage system having a first file system; and
computer program code effective for operating the computer,
the computer program code comprising:
first executable code effective for operating the computer to copy a plurality of one or more files from the client file system to the first file system thus creating a plurality of corresponding files in the first file system;
second executable code effective for operating the computer to delete the plurality of one or more files from the client file system thus recovering storage space in the client storage system occupied by the plurality of one or more files;
third executable code effective for operating the computer to create logical references associated with the plurality of one or more files, the logical references being located in the client file system and providing access to the plurality of corresponding files so that the plurality of one or more files can be referenced through the client file system though they have been deleted from the client file system;
fourth executable code effective for operating the computer to detect an access request to a first file of the plurality of one or more files by receiving a server access request to the corresponding file in the first file system via the logical reference associated with the first file and detecting the server access request; and
fifth executable code effective for operating the computer to respond to the access request by operating the computer to access its corresponding file in the first file system.

33. The data storage management computer of claim 32 wherein the first executable code is further effective for operating the computer to set last-access-time parameters of the corresponding files equal to last-access-time parameters of the plurality of one or more files.

34. The data storage management computer of claim 32 wherein the fifth executable code is effective for operating the computer to access the corresponding file by copying the file from the first file system back to the client file system.

35. The data storage management computer of claim 32 wherein the first executable code is further effective for operating the computer to copy least recently accessed files to the first file system, and only enough of the files so that an available storage capacity of the client storage system increases above a predetermined threshold.

36. The data storage management computer of claim 32 further including sixth executable code effective for operating the computer to detect when an available storage capacity of the client storage system decreases below a predetermined threshold, and in response thereto to cause execution of the first, second, and third program codes.

37. The data storage management computer of claim 32 wherein the computer program code is operable in a UNIX-based operating system, the computer program code including executable code effective for operating the computer to mount a directory tree in the first file system onto the client file system, thus providing access between the client file system and the first file system.

38. The data storage management computer of claim 37 wherein the logical references are symbolic links to the plurality of corresponding files in the first file system.

39. A computer program product for data storage management between a client file system in a first storage system and a server file system in a second storage system comprising:
one or more computer readable media having contained thereon computer program code suitable for being executed on a computer,
the computer program code comprising:
first executable code effective for operating the computer to copy a first plurality of one or more files from the second storage system to the first storage system, the first plurality of files having been previously copied from the first storage system, the number of files in the first plurality of files being such that an amount of storage space consumed in the first storage system increases above a first threshold value;
second executable code effective for operating the computer to delete the first plurality of files from the second storage system;
third executable code effective for operating the computer to copy a second plurality of one or more files from the first storage system to the second storage system;
fourth executable code effective for operating the computer to delete the second plurality of files from the first storage system thus recovering storage space in the first storage system occupied by the files, the number of files in the second plurality of files being such that the available storage capacity in the first storage device increases above a second threshold value; and
fifth executable code effective for operating the computer to create logical references in the first storage system associating the second plurality of files to their corresponding files in the second storage system so that the files can be referenced through the first storage system even though they have been deleted from the first storage system.

40. The computer program product of claim 39 wherein the computer program code is operable in a UNIX-based operating system.

41. The computer program product of claim 40 wherein the logical reference of each of the one or more files is a symbolic link to its corresponding file in the server file system.

42. A data storage management system comprising a data storage management computer containing and operating in accordance with the computer program product of claim 39.

43. A data storage system comprising:
a client site;
a server site;
means for copying one or more files from the client site to create corresponding files on the server site;
means for deleting the one or more files at the client site, wherein storage space consumed by the one or more files in the client site is recovered;
means for creating a logical reference at the client site for each of the one or more files, thereby associating each of the one or more files with their corresponding files on the server site;
means for detecting an access request for a first file of the one or more files;
means for deleting from the client site a logical reference associated with the first file;
means for copying the first file from the server site to the client site; and
means for deleting the first file at the server site.

44. The data storage system of claim 43 wherein enough files are copied to the server site such that an available storage capacity in the client site reaches a predetermined threshold.

45. The data storage system of claim 43 further including means for identifying a plurality of files to be copied from the client site to the server site, the plurality of files exclusive of files which have been determined will not be copied to the server site, the one or more files being taken from the plurality of files and being the least recently accessed files of the plurality of files.

46. A data storage system comprising:
a first storage system;
a second storage system;
means for copying a first plurality of one or more files from the second storage system to the first storage system, the first plurality of files having been previously copied from the first storage system, the number of files in the first plurality of files being such that an amount of storage space consumed in the first storage system increases above a first threshold value;
means for deleting the first plurality of files from the second storage system;
means for copying a second plurality of one or more files from the first storage system to the second storage system, the number of files in the second plurality of files being such that the available storage capacity in the first storage device increases above a second threshold value;
means for deleting the second plurality of files from the first storage system thus recovering storage space in the first storage system occupied by the files; and
means for creating logical references in the first storage system associating the second plurality of files to their corresponding files in the second storage system so that the files can be referenced through the first storage system even though they have been deleted from the first storage system.

47. The method of claim 46 wherein the first plurality of one or more files comprises files from a set of files stored on the second storage system, the set of files being files which had been previously copied from the first storage system, the first plurality of one or more files being the most recently accessed files in the set of files.

48. The method of claim 46 wherein the second plurality of one or more files comprises files from a set of files stored on the first storage system, the second plurality of one or more files being the least recently accessed files in the set of files.

49. A method for providing data storage comprising:
providing to a client site one or more computer readable media having contained thereon computer program code suitable for being executed on a computer, the computer being maintained by a client at the client site, the client site having a first storage system containing a client file system;
providing a server site having a server file system; and
requesting payment from the client for an amount based on the storage space consumed by the client site,
the computer program code comprising:
first executable code effective for operating the computer to copy a plurality of one or more files from the first storage system to the server file system, thus creating a plurality of corresponding files in the server file system;
second executable code effective for operating the computer to delete each of the one or more files from the client file system, thus recovering storage space in the first storage system occupied by the one or more files;
third executable code effective for operating the computer to associate a logical reference with each of the one or more files so that they can be accessed via the client file system though they have been deleted from the client file system;
fourth executable code effective for operating the computer to detect an access request to a first file of the one or more files; and
fifth executable code effective for operating the computer to respond to detection of the access request by operating the computer to copy the first file from the server file system to the client file system, to delete the first file from the server file system, and to remove the logical reference associated with the first file.

50. The method of claim 49 wherein the step of requesting payment is further based on an average amount of storage space consumed by the client site during a period of time.

51. The method of claim 49 wherein the step of requesting payment is further based on a maximum amount of storage space consumed by the client site during a period of time.

52. The method of claim 49 wherein the first executable code is further effective for operating the computer to copy least recently accessed files to the server file system, and only enough files so that an available storage capacity of the first storage system is above a predetermined threshold.

53. The method of claim 49 further including sixth executable code effective for operating the computer to detect when an available storage capacity falls below a predetermined threshold and in response thereto to execute the firs, second, and third program codes.

54. A method for providing data storage service for a client site having a client file system on a first storage system comprising:
providing a server site having a server file system;
providing data storage for said client site; and
requesting payment from the client site for an amount based on the storage space consumed by the client site,
the step of providing data storage comprising:
copying a plurality of one or more files from the first storage system to the server file system, thus creating a plurality of corresponding files in the server file system;
deleting each of the one or more files from the client file system, thus recovering storage space in the first storage system occupied by the one or more files, including creating logical references for the one or more files associated with the corresponding files in the server file system so that the one or more files can be referenced through the client file system though they have been deleted from the client file system, the logical reference being placed in the client file system;
detecting an access request to a first file of the one or more files; and
in response to detection of the access request, copying the first file from the server file system to the client file system, deleting the first file from the server file system, and removing the logical reference associated with the first file.

55. The method of claim 54 wherein the step of requesting payment is further based on an average amount of storage space consumed by the client site during a period of time.

56. The method of claim 54 wherein the step of requesting payment is further based on a maximum amount of storage space consumed by the client site during a period of time.

57. The method of claim 54 wherein detecting an access request of the first file includes making a server access request to the corresponding file in the server file system via the logical reference associated with the first file and detecting the server access request.

58. The method of claim 57 wherein the server file system is a UNIX-based operating system.

59. The method of claim 58 wherein the logical reference of each of the one or more files is a symbolic link on the client file system to its corresponding file in the server file system.

60. The method of claim 54 further including copying least recently accessed files to the server file system, and only enough files so that an available storage capacity of the first storage system is above a predetermined threshold.

61. The method of claim 54 further including detecting when an available storage capacity in the first storage system falls below a predetermined threshold, and in response thereto to perform the steps of copying a plurality of one or more files, deleting each of the one or more files, and associating a logical reference.

62. A method for storage space management of a first file system using a second file system and a third file system, the method comprising:
copying first files from the third file system to produce duplicated first files on the second file system, the first files being one or more of first original files, the first original files currently stored on the third file system but were originally stored on the first file system, the first files being the most recently accessed of the first original files;
deleting the first files from the third file system;
copying second files from the second file system to produce duplicated second files on the first file system, the second files being one or more of second original files, the second original files currently stored on the second file system but were originally stored on the first file system, the second files being the most recently accessed of the second original files;
deleting the second files from the second file system;
copying third files from the first file system to produce duplicated third files on the second file system, the third files being one or more of the least recently accessed files on the first file system;
deleting the third files from the first file system and creating in place thereof logical references to the duplicated third files on the second file system;
copying fourth files from the second file system to produce duplicated fourth files on the third file system, the fourth files being one or more of third original files, the third original files currently stored on the second file system but were originally stored on the first file system, the fourth files being the least recently accessed files of the third original files; and
deleting the fourth files from the second file system and creating in place thereof logical references to the duplicated fourth files on the third file system.

63. The method of claim 62 further including setting a last-access-time value of each duplicated file equal to a last-access-time value of its corresponding file prior to the copy operation.

64. The method of claim 62 wherein the file systems are UNIX-like file systems and the logical references are symbolic links.

65. The method of claim 64 wherein the first file system includes a first directory tree, the second file system includes a second directory tree, and the third file system includes a third directory tree, the method further including mounting the second directory tree on the first file system, mounting the third directory tree on the second file system, and mounting the first, second, and third directory trees in a controlling computer, the controlling computer configured to operate in accordance with the recited steps of copying and deleting.

66. A data storage management computer system programmed to operate in accordance with the method of claim 62.

67. A computer program product for storage space management of a first file system using a second file system and a third file system comprising:
one or more computer readable media containing a computer program suitable for execution on a computer,
the computer program comprising:
first executable program code effective for operating the computer to copy first files from the third file system to produce duplicated first files on the second file system, the first files being one or more of first original files, the first original files currently stored on the third file system but were originally stored on the first file system, the first files being the most recently accessed of the first original files;
second executable program code effective for operating the computer to delete the first files from the third file system;
third executable program code effective for operating the computer to copy second files from the second file system to produce duplicated second files on the first file system, the second files being one or more of second original files, the second original file currently stored on the second file system but were originally stored on the first file system, the second files being the most recently accessed of the second original files;
fourth executable program code effective for operating the computer to delete the second files from the second file system;
fifth executable program code effective for operating the computer to copy third files from the first file system to produce duplicated third files on the second file system, the third files being one or more of the least recently accessed files;
sixth executable program code effective for operating the computer to delete the third files from the first file system and to create in place thereof logical references to the duplicated third files on the second file system;
seventh executable program code effective for operating the computer to copy fourth files from the second file system to produce duplicated fourth files on the third file system, the fourth files being one or more of third original files, the third original file currently stored on the second file system but were originally stored on the first file system, the fourth files being the least recently accessed files of the third original files; and
eighth executable program code effective for operating the computer to delete the fourth files from the second file system and to create in place thereof logical references to the duplicated fourth files on the third file system.

68. The computer program product of claim 67 wherein the computer program code is suitable for execution under a UNIX-like operating system.

69. A method for data storage among a plurality of data storage systems comprising:
designating one of the data storage systems as a first selected system;
moving first files stored on the data storage systems other than the first selected system to the first selected system, including copying the first files to the first selected system to create copied first files and deleting the first files;
continuing the step of moving first files until the available storage capacity of the first selected system decreases below a first predetermined value;
designating one of the data storage systems as a second selected system;
moving second files stored on the second selected system to the other data storage systems, including copying each of the second files to one of the other data storage systems thus creating copied second files, deleting the second files from the second selected system, and in place of the deleted second files creating corresponding logical references to the copied second files; and
continuing the step of moving second files until the percentage of storage utilization of the second selected system decreases below a second predetermined value.

70. The method of claim 69 wherein the first files were originally stored on the first selected system and had subsequently been moved to the other data storage systems, the step of moving first files further including deleting logical references corresponding with the first files.

71. The method of claim 69 wherein the data storage systems each comprises a UNIX-based file system, the logical references being symbolic links.

72. The method of claim 71 further including mounting a portion of each of the file systems to a first file system.

73. The method of claim 72 wherein the first file system is located in one of the data storage systems.

74. The method of claim 72 wherein the first file system is located a data storage system other than the plurality of data storage systems.

75. The method of claim 69 wherein the first selected system has a highest available storage capacity among the data storage systems.

76. The method of claim 69 wherein the second selected system has a highest percentage of storage utilization among the data storage systems.

77. A computer program product for data storage management among a plurality of data storage systems comprising:
one or more computer program storage media containing computer program code suitable for execution on a computer system,
the computer program code comprising:
first program code effective for operating the computer to designate one of the data storage systems as a first selected system;
second program code effective for operating the computer to move first files stored on the data storage systems other than the first selected system to the first selected system, including copying the first files to the first selected system to create copied first files and deleting the first files, the number first files sufficient to reduce the available storage capacity in the first selected system to below a first predetermined value;
third program code effective for operating the computer to designate one of the data storage systems as a second selected system; and
fourth program code effective for operating the computer to move second files stored on the second selected system to the other data storage systems, including copying each of the second files to one of the other data storage systems thus creating copied second files, deleting the second files from the second selected system, and in place of the deleted second files creating corresponding logical references to the copied second files, the number of second files deleted from the second selected system being sufficient to reduce its percentage of storage utilization to below a second predetermined value.

78. The computer program product of claim 77 wherein the first files were originally stored on the first selected system and had subsequently been moved to the other data storage systems, the step of moving first files further including deleting logical references corresponding with the first files.

79. The computer program product of claim 77 wherein the computer program code is suitable for executing in a UNIX-based operating system.

80. The computer program product of claim 79 wherein the data storage systems each comprises a UNIX-based file system, the logical references being symbolic links.

81. The computer program product of claim 77 wherein the first selected system has a highest available storage capacity.

82. The computer program product of claim 77 wherein the first selected system has a highest available storage capacity.
